(19) United States
(12) Patent Application Publication
(10) Pub. No.: US 2025/0256487 A1
(43) Pub. Date: Aug. 14, 2025

(54) COLD-FORMED GLASS ARTICLES WITH OVERMOLDED CARRIERS AND METHODS OF FABRICATING THE SAME

(71) Applicant: CORNING INCORPORATED, CORNING, NY (US)

(72) Inventors: Khaled Layouni, Fontainebleau (FR); Gregory Roger Martin, Acton, ME (US); Torsten Nath, Berlin (DE); Christopher Lee Timmons, Big Flats, NY (US)

(21) Appl. No.: 18/854,855

(22) PCT Filed: Mar. 29, 2023
(86) PCT No.: PCT/US2023/016706

§ 371 Date: Oct. 7, 2024

Related U.S. Application Data
(60) Provisional application No. 63/330,058, filed on Apr. 12, 2022.

(51) Int. Cl. B32B 17/10; B29C 45/14; B29L 31/30; B32B 1/00; B32B 7/027; B32B 7/04; B32B 27/20; B32B 27/28; B32B 27/36

(52) U.S. Cl. CPC B32B 17/10; B29C 45/14434; B29C 45/14688; B29C 45/14778; B32B 1/00; B32B 7/027; B32B 7/04; B32B 27/20; B32B 27/28; B32B 27/365; B29L 2031/3052; B32B 2255/26; B32B 2262/101; B32B 2262/106; B32B 2307/75; B32B 2605/003; B32B 2605/08

(57) ABSTRACT

A glass article comprises a glass substrate, a decorative ink layer disposed on a major surface of the glass substrate, and a carrier that is injection molded onto and bonded to the decorative ink layer. The carrier comprises a main body comprising a surface bonded to the ink layer without an adhesive layer being disposed between the decorative ink layer and the surface and a plurality of connection elements extending from the main body or incorporated into the main body. A support structure comprising a plurality of retention elements that are mechanically engaged with the plurality of connection elements to retain the glass substrate and the carrier on the support structure in a curved configuration.

### PRIORITY

This application claims the benefit of priority under 35 U.S.C. § 119 of U.S. Provisional Application Ser. No. 63/330,058 filed on Apr. 12, 2022, the content of which is relied upon and incorporated herein by reference in its entirety.

### BACKGROUND

The disclosure relates to cold-formed glass articles including a glass substrate and an insert molded carrier and, more particularly, to vehicle interior systems such as decorative trim elements comprising such cold-formed glass articles.

Glass substrates can be beneficially used to form various curved surfaces in an interior of a vehicle. Glass provides favorable optical and mechanical properties over conventionally used plastic-based materials. Cold-forming or cold-bending techniques may beneficially allow various processing steps (e.g., finishing, coating with functional films) to be performed on the glass substrate while the glass substrate is flat, and subsequently bent just prior to incorporation into a vehicle, thereby saving production and shipment costs. Certain existing methods for cold-forming glass substrates rely on the application of adhesive to the glass substrate after the glass substrate is bent. The application of adhesive introduces complexity and cost into the cold-forming process. Accordingly, an alternative method of cold-forming glass substrates is needed.

### SUMMARY

In one embodiment of the present disclosure pertains to a glass article comprising a glass substrate comprising a first major surface and a second major surface opposite the first major surface, a decorative ink layer disposed on the second major surface of the glass substrate, and carrier that is injection molded onto and bonded to the decorative ink layer. The carrier comprises a main body comprising a surface bonded to the ink layer without an adhesive layer being disposed between the decorative ink layer and the surface, and a plurality of connection elements extending from the main body or incorporated into the main body. A support structure comprises a plurality of retention elements that are mechanically engaged with the plurality of connection elements to retain the glass substrate and the carrier on the support structure in a curved configuration.

In another embodiment, a glass article comprises a glass substrate comprising a first major surface and a second major surface opposite the first major surface, wherein the glass substrate comprises a planar shape, a decorative ink layer disposed on the second major surface of the glass substrate, and a carrier that is injection molded onto and directly bonded to the decorative ink layer or an optional adhesion promotion layer disposed thereon. The carrier comprises a planar-shaped main body comprising a surface bonded to the decorative ink layer without an adhesive layer being disposed between the decorative ink layer and the surface; and a plurality of connection elements extending from the main body or incorporated into the main body. The carrier is less stiff than the glass substrate. The direct bonding between the glass substrate and the carrier via the decorative ink layer allows carrier and the glass substrate to be simultaneously bent to a radius of curvature that is less than or equal to 1.0 m without the carrier debonding from the glass substrate.

In another embodiment, a method of fabricating a cold-formed glass article comprises depositing a decorative ink layer on a major surface of a glass substrate; disposing the glass substrate in a mold cavity defined between a first die and a second die, wherein the second die comprises a discontinuous mold surface that is not in contact with the glass substrate when the glass substrate is disposed in the mold cavity; injecting a polymeric material into the mold cavity such that the polymeric material fills a volume between the discontinuous mold surface and the glass substrate; solidifying the polymeric material to form a carrier that is directly bonded to the decorative ink layer or an adhesion promotion layer optionally disposed thereon; and cold-forming the glass substrate into a curved configuration.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of a vehicle interior with vehicle interior systems, according to one or more embodiments of the present disclosure;

FIG. 2 schematically depicts a cross-sectional view of a decorative trim element of a vehicle interior system through the line II-II depicted in FIG. 1, according to one or more embodiments of the present disclosure;

FIG. 3A schematically depicts a cross-sectional view of a glass substrate disposed in a mold cavity, according to one or more embodiments of the present disclosure;

FIG. 3B schematically depicts a cross-sectional view of a glass substrate disposed in the mold cavity of FIG. 3A with a polymeric material being injected into the mold cavity onto the glass substrate, according to one or more embodiments of the present disclosure;

FIG. 3C schematically depicts a glass article formed from the glass substrate and the polymeric material depicted in FIGS. 3A and 3B, according to one or more embodiments of the present disclosure;

FIG. 4A schematically depicts a cross-sectional view of a glass substrate disposed in a mold cavity comprising a curved surface, according to one or more embodiments of the present disclosure;

FIG. 4B schematically depicts a cross-sectional view of a glass substrate disposed in the mold cavity of FIG. 4A with a polymeric material being injected into the mold cavity onto the glass substrate, according to one or more embodiments of the present disclosure;

FIG. 4C schematically depicts a glass article formed from the glass substrate and the polymeric material depicted in FIGS. 4A and 4B, according to one or more embodiments of the present disclosure;

FIG. 5A schematically depicts a cross-sectional view of a first edge portion of a glass article, according to one or more embodiments of the present disclosure;

FIG. 5B schematically depicts a cross-sectional view of a second edge portion of a glass article, according to one or more embodiments of the present disclosure;

FIG. 5C schematically depicts a cross-sectional view of a third edge portion of a glass article, according to one or more embodiments of the present disclosure;

FIG. 5D schematically depicts a cross-sectional view of a fourth edge portion of a glass article, according to one or more embodiments of the present disclosure;

FIG. 6 depicts a flow diagram of a method of fabricating a cold-formed glass article, according to one or more embodiments of the present disclosure;

FIG. 7 schematically depicts a plan view of a glass article comprising a segmented carrier, according to one or more embodiments of the present disclosure;

FIG. 8A schematically depicts a first pattern of relative bond strength between a carrier and a glass substrate, according to one or more embodiments of the present disclosure;

FIG. 8B schematically depicts a second pattern of relative bond strength between a carrier and a glass substrate, according to one or more embodiments of the present disclosure;

FIG. 8C schematically depicts a third pattern of relative bond strength between a carrier and a glass substrate, according to one or more embodiments of the present disclosure; and

FIG. 9 schematically depicts a glass substrate, according to one or more embodiments of the present disclosure.

### DETAILED DESCRIPTION

Referring generally to the figures, described herein are embodiments of glass articles comprising a glass substrate, a decorative ink layer disposed on a major surface of the glass substrate, and a carrier that is injection molded and bonded to the glass substrate via the decorative ink layer. The carrier may be injection molded onto the decorative ink layer using a suitable insert molding process where the glass substrate is initially placed onto a surface of a first die forming a mold cavity. A suitable polymeric material may be injected into the mold cavity so as to form the carrier on the decorative ink layer. The material of the decorative ink layer and the carrier may be selected to bond to one another and thereby eliminate the need for an adhesive between the decorative ink layer and the carrier. Not only does this process beneficially eliminate the need for an adhesive, but also provides flexibility for incorporating various features into the carrier to facilitate cold-forming the glass substrate and providing long-term reliability. In embodiments, a second die forming the mold cavity in conjunction with the first die comprises a discontinuous mold surface. The discontinuous mold surface may be shaped to form a plurality of features in the carrier with the polymeric material. For example, in embodiments, the carrier comprises a main body and a plurality of connection elements that extend from the main body or are incorporated into the main body. The plurality of connection elements may be shaped for mechanical engagement with a support structure associated with a vehicle interior system to facilitate attachment of the carrier to the support structure without the use of an adhesive. As such, the fabrication methods described herein provide a polymeric carrier that is attached to the glass substrate and also includes connection elements for downstream processing. Such a process is more efficient than certain existing cold-forming processes requiring the use of an adhesive to attach a glass substrate with a pre-formed carrier.

In embodiments, the carrier formed by the insertion molding process described herein may be less rigid than the glass substrate such that, when removed from the mold cavity, the combined structure of the carrier and glass substrate returns to the initial shape of the glass substrate. As such, in embodiments where the glass substrate is initially flat and planar, the stack of the carrier and glass substrate may also be flat and planar once removed from the mold cavity. Such embodiments are beneficial in that it is less costly to ship flat parts than curved parts. In such embodiments, the plurality of connection elements may be particularly beneficial in that they may facilitate cold-forming the glass substrate via engagement with a support structure. The support structure may contain a plurality of retention elements that are arranged to mechanically engage with the plurality of connection elements and cold-form the glass article efficiently without the use of additional adhesive. The carrier structures described herein facilitate efficient fabrication, shipment, and assembly of cold-formed glass articles.

In embodiments, the carrier formed by the insertion molding process described herein may include features to relieve strain in the carrier. Such features are particularly beneficial in embodiments where the carrier is cold-formed in conjunction with the glass substrate. For example, in embodiments, the carrier comprises a plurality of negative surface features (e.g., slots, grooves, cavities, holes, pits) that reduce bending stresses in the carrier from cold-forming by reducing the rigidity of select areas of the carrier. In embodiments, the negative surface features extend perpendicular to the direction in which the glass substrate is bent and are arranged proximate to the plurality of connection elements to relieve bending strain in areas of the carrier experiencing relatively high bending stress from the cold-forming. Additionally, the flexibility of the insert molding process described herein allows carriers with different peripheral extensions to be constructed. The peripheral extensions may protect edges or minor surfaces of the glass substrates by contacting or at least partially surrounding the edges. The peripheral extensions may also increase the bonding strength between the glass substrate and carrier.

In embodiments, the carrier is formed of a material having a coefficient of thermal expansion (“CTE”) that resembles that of the glass substrate (measured from 25° C. to 300° C.) to minimize thermally-induced stresses. In embodiments, the polymeric material injected into the mold cavity comprises at least 20% by volume (e.g., at least 25% by volume, at least 30% by volume, at least 35% by volume, at least 40% by volume) of a suitable additive (e.g., carbon fiber, glass fiber) so that the carrier CTE resembles that of the glass. In embodiments, the carrier is segmented into a plurality of portions having at least one degree of freedom relative to one another to prevent thermal-induced stress buildup in the carrier. In embodiments, the bonding strength between the carrier and the decorative ink layer varies as a function of location in a pattern designed to reduce thermally-induced stresses in the carrier. For example, the decorative ink layer may be selectively textured through a suitable additive (e.g., filament printing) or subtractive (e.g., etching) or plasma treatment technique to provide a spatially-variable bonding strength. In embodiments, after removal from the mold cavity, additional energy (e.g., indirect or direct heating by conduction or convection, laser heating, ultrasonic welding) is applied to the carrier to cause the carrier to bond to areas of the decorative ink layer with greater strength. In embodiments, to facilitate bonding by laser welding, the carrier may be formed from carbon black-filled polymer materials for laser absorption/heat generation to facilitate bonding. Areas of the carrier that are less rigorously bonded to the decorative ink layer may move relative to the glass substrate upon thermal expansion and contraction, thereby preventing stress accumulation. In embodiments, the carrier is formed using a sequential injection molding process with different polymeric materials to form a multi-material carrier. A first carrier portion directly bonded to the decorative ink layer may be formed of a material having a lower Young's modulus than a second carrier portion to relieve thermal stresses from any CTE mismatch between the glass substrate and carrier.

Unless expressed otherwise herein, CTE is measured from 25° C. to 300° using a push-rod dilatometer in accordance with ASTM E228-11 (2016).

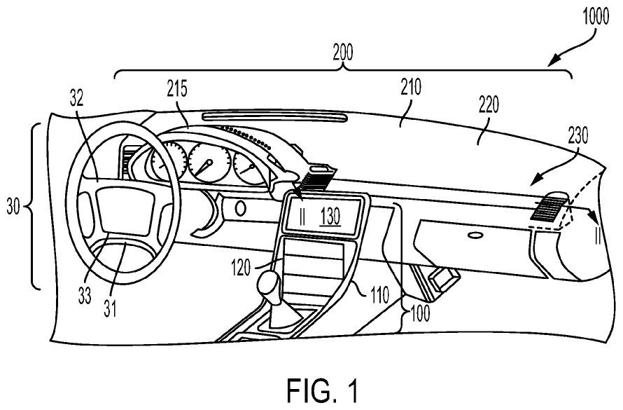

FIG. 1 shows an exemplary vehicle interior 1000 that includes three different embodiments of a vehicle interior system 100, 200, 30. Vehicle interior system 100 includes a frame, shown as center console base 110, with a curved surface 120 including a display 130. Vehicle interior system 200 includes a frame, shown as dashboard base 210, with a curved surface 220 including an interior trim element 230. The dashboard base 210 typically includes an instrument panel 215 which may also include a display. Vehicle interior system 30 includes a frame, shown as steering wheelbase 31, with a curved surface 32 and a display 33. In embodiments, the display 130, interior trim element 230, and display associated with the instrument panel 215 may comprise any of the cold-formed glass articles described herein. In embodiments, the interior trim element 230 does not include a display panel. As such, the cold-formed glass articles described herein may be used either with or without a display panel.

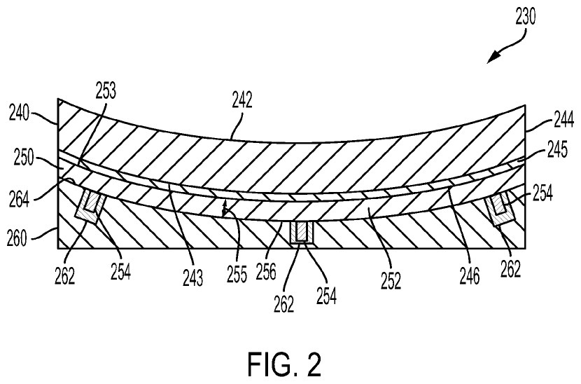

In embodiments, the interior trim element 230 comprises a glass substrate 240 (see FIG. 2) that is cold-formed into a suitable curved shape. The interior trim element 230 may serve as a decorative component of the vehicle interior 1000. As such, the particular shape of the interior trim element 230 is not particularly limiting and may vary depending on the application. In embodiments, the interior trim element 230 may incorporate a display (e.g., attached to the glass substrate 240 or carrier 250, see FIG. 2) that is visible through the glass substrate 240. The display may be curved or flat, and comprise any suitable type of display panel. In embodiments, the interior trim element 230 incorporates one or more light sources (e.g., light emitting diodes, lasers) that may alter the visual appearance of the interior trim element 230. In embodiments, such light sources at least partially overlap icons formed in the interior trim element 230 (e.g., outlined by the carrier 250) such that back-lit icons are visible to the user. In embodiments, such back-lit icons comprise a touch functionality (e.g., a touch panel may be disposed between the glass substrate 240 and carrier 250 in some embodiments) to allow the user to control another vehicle system (e.g., sound system, heating and cooling system). Any suitable set of functionalities may be provided to the interior trim element 230. It should also be appreciated that the interior trim element 230 is not limited to a particular size or shape.

It should be understood that vehicle interior systems other than the vehicle interior systems 100, 200, 30 depicted in FIG. 1 may incorporate the cold-formed glass articles described herein. The cold-formed glass articles described herein may be incorporated into any portion of an interior of a vehicle that includes a curved surface, such as, but not limited to, an arm rest, a pillar, a roof, a seatback, a floor board, a headrest, a door panel, or any portion of the interior of a vehicle that includes a curved surface.

FIG. 2 schematically depicts a cross-sectional view of the interior trim element 230 through the line II-II of FIG. 1, according to an example embodiment. As shown, the interior trim element 230 comprises a glass substrate 240, a decorative ink layer 245, a carrier 250, and a support structure 260. The glass substrate 240 comprises a first major surface 242, a second major surface 243 opposite the first major surface 242, and a minor surface 244 extending between the first major surface 242 and the second. The first major surface 243 generally faces the vehicle interior 1000 (see FIG. 1) and may be most proximate to users. The minor surface 244 may define a peripheral edge of the glass substrate 240. In embodiments, the glass substrate 240 comprises a plurality of minor surfaces 244 forming a plurality of peripheral edges of the glass substrate 240.

The glass substrate 240 may be formed of any suitable glass material (e.g., an aluminosilicate glass, a borosilicate glass, a soda lime glass, and alkali aluminosilicate glass). In embodiments, glass material may be selected based on its weight, aesthetic appearance, thermal properties (e.g., coefficient of thermal expansion), and mechanical properties (e.g., Young's modulus, Poisson's ratio). In embodiments the glass material may be selected based on the glass material's optical transmission properties (e.g., the glass may include one or more coloring agents). In embodiments, the glass substrate 240 comprises an optical transmission of greater than or equal to 60% throughout the visible spectrum (e.g., from 380 nm to 730 nm) such that the glass substrate 240 appears substantially transparent. Embodiments are also envisioned where the glass substrate 240 exhibits a non-neutral color appearance when viewed from the first major surface 242.

The decorative ink layer 245 is disposed on the second major surface 243 of the glass substrate 240. The decorative ink layer 245 may be deposited on the second major surface 243 using existing coating (e.g., spin coating, spraying) or printing (e.g., inkjet printing) techniques. The decorative ink layer 245 may comprise a suitable pigment or combination of pigments dispersed in a binder system. In embodiments, the decorative ink layer 245 is patterned such that the interior trim element 230 exhibits a desired appearance (e.g., a brushed metal appearance, a wood grain appearance, a leather appearance, a colored appearance, etc.). In embodiments, the decorative ink layer 245 comprises an optical transmission that is less than the glass substrate 240 throughout at least some of the visible spectrum, such that the decorative ink layer 245 conceals the support structure 260 of the interior trim element 230 from view.

The decorative ink layer 245 may be formed of any suitable material and comprise any suitable pigment dispersion. In embodiments, the material of the decorative ink layer 245 is selected to bond with both the glass substrate 240 and the carrier 250. In the depicted embodiment, the decorative ink layer 245 is directly bonded to the carrier 250. In such embodiments, the material of the decorative ink layer 245 may be selected to molecularly intermingle with injected polymer material out of which the carrier 250 is formed during the insert molding process described herein. In such embodiments, functionality (active or polarity) on the surfaces of the decorative ink layer 245 is desired to facilitate molecular intermingling with the injected polymer materials. Potential suitable materials for the decorative ink layer 245 may include acrylic-based inks, epoxy-based inks, urethane-based inks, combination inks, thermoplastic polyolefin, thermoplastic polyurethane, and combinations thereof. Embodiments are also envisioned where the decorative ink layer 245 comprises a plurality of sub-layers. For example, a first sub-layer may be directly bonded to the glass substrate and a second sub-layer may be directly bonded to the first sub-layer. The sub-layers may be selected to provide the desired appearance in combination.

In embodiments, the interior trim element 230 comprises an optional adhesion promotion layer (not depicted) disposed between the decorative ink layer 245 and the carrier 250, such that the carrier 250 is directly bonded to the adhesion promotion layer. The adhesion promotion layer may comprise a chemical primer, a paint, or another ink applied to the decorative ink layer 245 prior to the insert molding process described herein. The adhesion promotion layer may be selected to facilitate the formation of bonds with the liquid polymer material used to form the carrier 250, while bonding with the decorative ink layer 245. In embodiments, the e-coating or paint layers described in U.S. Provisional Patent Application No. 63/256,669, filed on Oct. 18, 2021, hereby incorporated by reference in its entirety, may be used as an adhesion promotion layer.

In embodiments, a surface 246 of the decorative ink layer 245 that is not bonded to the glass substrate 240 is processed to facilitate bonding between the carrier 250 and the decorative ink layer 245. For example, texture may be imparted on the surface 246 using a suitable etching or abrasion technique. In embodiments, filaments (e.g., of a suitable plastic material) are additively disposed on the surface 246 to facilitate bonding with the carrier 250. In embodiments, the solution of the ink applied during formation of the decorative ink layer 245 may be varied during deposition to spatially vary the texture of the decorative ink layer 245 to increase surface area and facilitate bonding. In embodiments, the surface 246 is treated to have a relatively high surface free energy via a suitable plasma treatment (e.g., an atmospheric plasma treatment, oxygen plasma treatment, corona discharge treatment) to facilitate bonding. Any of the plasma treatments described in U.S. Provisional Patent Application No. 63/189,943, filed on May 18, 2021, hereby incorporated by reference in its entirety) may be used. In embodiments, after the insert injection molding process described herein, the carrier 250 may be subjected to additional heat treatments (e.g., via localized application of heat via laser, ultrasonic radiation, heating in a furnace, exposure to infrared radiation, conductive or convective heating) to increase the bond strength between the carrier 250 and the decorative ink layer 245 over that resulting from the injection molding process. As described herein, such bonding-enhancing treatments may be applied in a suitable pattern to relieve CTE-mismatch induced stresses. To facilitate such direct bonding processes by application of heat, the carrier may be formed from (as an alternative or in addition to the other materials described herein) ethylene-vinyl acetate with a crosslinker to increase the upper use temperature.

The bonding between the glass substrate 240 and the carrier 250 via the decorative ink layer 245 may cause thermally-induced stresses in the carrier 250 when the interior trim element 230 encounters variable temperatures associated with an operating environment. Differences in coefficient of thermal expansion between the glass material of the glass substrate 240 and the carrier 250 may cause stress buildup in the carrier 250, as the carrier 250 may comprise a relatively high-CTE material. Suitable polymer materials that are compatible with the insert molding processes described herein may include polycarbonate-acrylonitrile butadiene styrene, glass-filled polycarbonates, carbon-filled polycarbonates, polyacrylamide, glass-filled polycarbonate-acrylonitrile butadiene styrene, carbon-filled polycarbonate-acrylonitrile butadiene styrene, polyphenylene sulfide, glass-filled polyphenylene sulfide, carbon-filled polyphenylene sulfide, or combinations thereof. In embodiments, the carrier 250 comprises a polymeric matrix (e.g., of one of the aforementioned materials) with at least 20% by volume of a relatively low CTE-based filler material (e.g., carbon or glass fibers). In embodiments, the relatively low CTE-based filler material is selected such that the CTE of the carrier 250 approximates that of the glass substrate 240 (e.g., within 20 ppm/° C.) to minimize stresses in the carrier 250 and improve longevity in the interior trim element 230. Embodiments, the CTE of the carrier may be greater than or equal to 5 ppm/° C. and less than or equal to 20 ppm/° C. As described herein, the carrier 250 may comprise a segmented structure with one or more stress relieve joints to alleviate thermally-induced stress buildup. In embodiments, the carrier 250 is constructed of multiple materials, with a relatively low Young's modulus material being bonded to the decorative ink layer 245 to aid in reducing thermally-induced stresses in the carrier 250.

In embodiments, the carrier 250 comprises a main body 252 and a plurality of connection elements 254 that are extending from or integrated into the main body 252. The main body 252 may include a surface 253 that generally corresponds in shape to the second major surface 243 of the glass substrate 240 as a result of the insert injection molding process described herein. The surface 253 is bonded to the decorative ink layer 245 as a result of the injection molding process described herein. In embodiments, the main body 252 comprises a homogenous material composition of the polymeric material and optional filler materials described herein. The main body 252 comprises a thickness 255 extending between the surface 253 and a second surface 256 that is opposite the surface 253. The thickness 255 and composition of the main body 252 may vary depending on the embodiment. For example, in embodiments, the main body 252 is formed of a material and the thickness 255 is selected such that the main body 252 is less stiff (e.g., less resistant to bending) than the glass substrate 240 such that, in the absence of any external forces being applied to the carrier 250 and glass substrate 240, the rigidity of the glass substrate 240 causes the carrier 250 and glass substrate 240 to “spring back” to the original shape of the glass substrate 240 (e.g., if the glass substrate 240 initially planar and flat prior to being subjected to the insert injection molding process described herein, the glass substrate 240 may retain to that shape after removal from a mold cavity, even if the main body 252 is formed to have a curved shape). Such embodiments may beneficially facilitate the fabrication of flat carrier-glass substrate assemblies that can be shipped at relatively low costs.

In embodiments, the thickness 255 and composition of the main body 252 may be such that the main body 252 is stiffer (e.g., more resistant to bending) than the glass substrate 240. Such embodiments may facilitate the glass substrate 240 being cold-formed during the insert injection molding process described herein, such that the main body 252 retains the glass substrate 240 in a shape that deviates from an initial shape of the glass substrate 240 (e.g., an initially flat glass substrate may be retained in a non-planar or curved shape).

In embodiments, the main body 252 comprises a single piece of material that substantially covers the surface area of the second major surface 243. For example, in embodiments, the main body 252 covers at least 60% (e.g., at least 70%, at least 75%, at least 80%, at least 90%, at least 100%) of the surface area of the second major surface 243. Such coverage beneficially enables a distribution of force to be applied to the main body 252 in connecting the carrier 250 to the support structure 260, as described herein. Embodiments are also envisioned where the main body 252 is segmented into a plurality of separate pieces of material (e.g., having the same or different material compositions) that are separated from one another via one or more stress relief joints that may relive bending-induced stresses in the carrier 250. In such embodiments, the combined surface area of all the separate pieces may substantially cover the second major surface 243. Embodiments are envisioned where the main body 252 covers less than 50% of the surface area of the second major surface 243. For example, the main body 252 may comprise a strip of polymeric material having a width that is less than 50% of the glass substrate 240. Such embodiments may provide flexibility in the way that the carrier 250 is attached to the support structure 260, while limit the surface area that may be used for connections. Embodiments are also envisioned where the main body 252 comprises one or more open regions or apertures to facilitate attachment of a light source or display panel to the glass substrate 240 or carrier 250, such that the light source or display panel is visible through the glass substrate 240. For example, embodiments are envisioned where the main body 252 takes the form of the frames described in U.S. patent application Ser. No. 15/860,850, filed on Jan. 3, 2018, hereby incorporated by reference in its entirety.

Referring still to FIG. 2, the plurality of connection elements 254 serve to mechanically connect the main body 252 with the support structure 260. The support structure 260 may generally include a rigid base for the interior trim element 230. In embodiments, the support structure 260 is attached directly to additional components of the vehicle interior 1000. The support structure 260 generally serves to position the interior trim element 230 in a desired position and orientation with the vehicle interior 1000. In embodiments, the support structure 260 comprises a plurality of retention elements 262 that are configured to mechanically engage with the plurality of connection elements 254 of the carrier 250 such that the carrier 250 is secured to the support structure 260. The role of the mechanical engagement between the plurality of connection elements 254 and the plurality of retention elements 262 may vary depending on the implementation. For example, in embodiments where the main body 252 is less rigid than the glass substrate 240, the mechanical engagement between the plurality of connection elements 254 and the plurality of retention elements 262 may serve to cold-form the combination of the glass substrate 240 and the carrier 250. In such embodiments, the plurality of retention elements 262 may be arranged to receive or otherwise engage with the plurality of connection elements 254 when the glass substrate 240 is cold-formed into a desired curved shape, such that the mechanical connection between the carrier 250 and the support structure 260 retains the glass substrate 240 in the desired curved shape. Embodiments are also envisioned where the glass substrate 240 is cold-formed into the desired curved shape during the injection molding process (e.g., the glass substrate 240 may be cold-formed while the polymeric material used to form the carrier 250 is injected into the mold cavity) and the mechanical engagement between the plurality of connection elements 254 and the plurality of retention elements 262 serves to retain the glass substrate 240 in a desired position and orientation.

A variety of forms for the plurality of connection elements 254 and the plurality of retention elements 262 are contemplated and within the scope of the present disclosure. In the depicted embodiment, the plurality of connection elements 254 extend from the main body 252. The plurality of connection elements 254 may be integrally formed with the main body 252 and be constructed of the same material as the main body 252 or be formed from a different material than the main body 252. In embodiments, the plurality of connection elements 254 may comprise extension tabs and the plurality of retention elements 262 may comprise positive features (e.g., protrusions, rods, bumps, plateaus) that are inserted through openings in the extension tabs to secure the carrier 250 in a desired configuration. In embodiments, the plurality of connection elements 254 may comprise fasteners (e.g., screws) extending from the main body 252 that are inserted into the plurality of retention elements 262, which may be openings (e.g., threaded openings). In embodiments, the plurality of connection elements 254 may comprise compressible features (e.g., a protruding rod with a slot, channel or gap) that may be compressed for insertion into the plurality of retention elements 262 for securing the glass substrate 240 to the support structure 260. In embodiments, the plurality of connection elements 254 comprise openings in the main body 252 and the plurality of retention elements 262 may be inserted into the openings. Any suitable combination of structures may be used to facilitate mechanically connecting the carrier 250 to the support structure 260.

In embodiments, the carrier 250 is constructed of a porous foamed material formed via injection molding (e.g., a foamed plastic formed from a base polymer, foaming agent, catalyst, and stabilizer). In such embodiments, the plurality of connection elements 254 may be embedded into the foamed material and be constructed of a material (e.g., a metallic material) that differs from the carrier 250 to facilitate cold-forming the glass substrate 240.

The support structure 260 may take a variety of forms depending on the implementation. In the depicted embodiment, the support structure 260 comprises a curved surface 264 having a shape that substantially corresponds to a desired shape of the first major surface 242 of the glass substrate 240. The glass substrate 240 and carrier 250 may be cold-formed against the curved surface 264 (e.g., such that the carrier 250 directly contacts the support structure 260) and the plurality of retention elements 262 (formed in the curved surface 264 in the depicted embodiment) may retain the carrier 250 against the curved surface 264. In embodiments, the cold forming process is performed at a temperature less than the glass transition temperature T_{g} of the glass substrate 52. In particular, the cold forming process may be performed at room temperature (e.g., about 20° C.) or a slightly elevated temperature, e.g., at 200° C. or less, 150° C. or less, 100° C. or less, or at 50° C. or less. Such a structure may beneficially prevent vibrations of the carrier 250 against the support structure 260 by eliminating any gaps between the carrier 250 and the support structure 260. Alternative embodiments are also envisioned where at least a portion of the support structure 260 does not overlap the carrier 250 (e.g., the support structure 260 may comprise a frame that surrounds the main body 252, and the plurality of connection elements 254 may extend outward from the main body 252 to engage with the plurality of retention elements 262). Any suitable support structure may be used.

In embodiments, the polymeric material used to construct the carrier 250 has an optical transmission that is substantially lower than the glass substrate 240 (e.g., the optical transmission of the carrier 250 may be less than or equal to 10% or 5% throughout the visible spectrum). In embodiments, the polymeric material used to construct the carrier 250 exhibits a relatively dark and neural appearance (e.g., with CIELAB a* and b* values having magnitudes less than 5.0) to prevent the carrier 250 from altering the appearance of any patterns formed in the decorative ink layer 245 when the interior trim element 230 is viewed from the first major surface 242 from within the vehicle interior 1000.

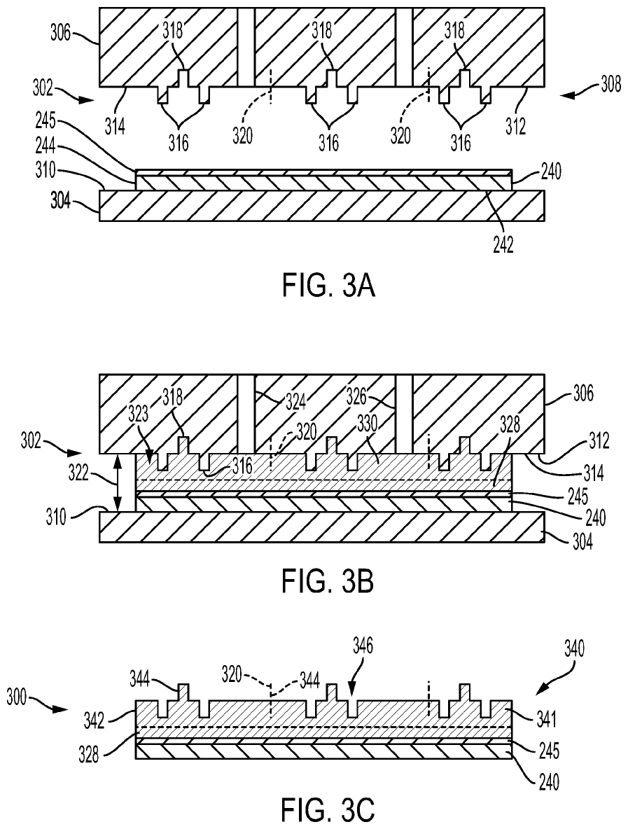

FIGS. 3A, 3B, and 3C schematically depict cross-sectional views of various stages of an insert injection molding process for forming a glass article 300, according to an example embodiment of the present disclosure. The glass article 300 may include the glass substrate 240 and decorative ink layer 245 described herein with respect to FIG. 2. Accordingly, like reference numerals are incorporated into FIGS. 3A, 3B, and 3C to signify the incorporation of like components. As depicted in FIG. 3A, an initial step in the injection molding process may include positioning the glass substrate 240 in a mold cavity 302 defined between a first die 304 and a second die 306 of an injection molding apparatus 308. The glass substrate 240 may be positioned on the first die 304 such that the first major surface 242 contacts a first mold surface 310 of the first die 304. The first mold surface 310 may have a shape that substantially corresponds to the first major surface 242 of the glass substrate 240 prior to cold-forming. For example, both the first major surface 242 and the first mold surface 310 may be substantially flat and planar such that the first mold surface 310 lies flush against the first major surface 242. Embodiments are also envisioned where the first mold surface 310 deviates in shape from the first major surface 242 and/or is non-planar.

As shown, the mold cavity 302 is further defined by a second mold surface 312 associated with the second die 306. The second mold surface 312 is discontinuous in shape to facilitate forming one or more structures in a carrier of polymeric material. As used herein, the term “discontinuous surface” means that the surface comprises at least one inflection point (e.g, corner) such that the surface is not continuously curved at a constant curvature or flatness over the entirety thereof. The second mold surface 312 is shaped based on a desired structure of the carrier to be formed via injection molding. In embodiments, the second mold surface 312 comprises a base portion 314 extending parallel to the first mold surface 310. The base portion 314 may constitute a majority of the surface area of the second mold surface 312. In embodiments, the base portion 314 is shaped based on a desired shape of a surface of the main body of a carrier that is not bonded to the decorative ink layer 245.

In embodiments, the second mold surface 312 comprises one or more positive surface features 316 (e.g., protrusions, bumps, mesas, plateaus) that extend from the base portion 314 towards the first mold surface 310 into the mold cavity 302. The one or more positive surface features 316 may be used to form negative features (e.g., slots, channels, cavities) in a carrier formed via the injection molding process. Such negative features may aid in reducing bending stresses in the carrier when the carrier is cold-formed. In embodiments, when the mold cavity 302 is closed, at least one of the positive surface features 316 may extend an entirety of the distance between the first mold surface 310 and the second mold surface 312 to separate the mold cavity 302 into sub-cavities that may optionally be fluidly isolated from one another (e.g., such that polymeric material is delivered to each of the sub-cavities separately). Such a structure may allow multiple segments of a carrier to be formed simultaneously to form stress relief features in the carrier.

In embodiments, the second mold surface 312 comprises one or more negative surface features 318 (e.g., slots, channels, cavities) that extend from the base portion 314 away from the first mold surface 310. The one or more negative surface features 318 may be used to form positive features (e.g., protrusions, bumps, mesas, plateaus) in the carrier. The positive and negative surface features formed from the second mold surface 312 may form the connection elements of the carriers described herein.

In embodiments, one or more inserts 320 extend from the second die 306 into the mold cavity 302. The inserts 320 may be loosely attached (e.g., inserted into slots and held via friction, attached with a suitable adhesive) to the second die 306 and extend into the mold cavity 302. The one or more inserts 320 may eventually be incorporated into the carrier formed via injection molding and be embedded in the polymeric material to form one or more features (e.g., connection elements) in the carrier. In embodiments, the inserts 320 are formed of a suitable metallic material or other suitable material. The inserts 320 provide flexibility in constructing the carrier.

In embodiments, the first die 304 and the second die 306 are formed of any suitable material. In embodiments, the first die 304 and the second die 306 may be formed from plastic materials (e.g., PC-ABS, PVC, Delrin, etc.) or metals (e.g., aluminum alloys, iron alloys, etc.). In embodiments, the first and second mold surfaces 310 and 312 comprise a coating material that limits or prevents scratches on glass substrate 240 during molding. In embodiments, a protective non-stick film is disposed between the glass substrate 240 and the first and second mold surfaces 310 and 312.

As shown in FIG. 3B, after the glass substrate 240 is positioned within the mold cavity 302, the mold cavity 302 may be closed. For example, the injection molding apparatus 308 may move the second die 306 and the first die 304 relative to one another until the mold cavity 302 is in a desired closed configuration for injection. In an example, first die 304 and second die 306 are moved relative to one another until the base portion 314 of the second mold surface 312 is positioned a distance 322 from the first mold surface 310. The distance 322 may correspond to a desired thickness of a main body for a carrier to be fabricated. In embodiments, upon closing, the environment of the mold cavity 302 may be heated to a suitable injection temperature where the polymeric material to be injected is in a molten state.

In embodiments, a polymeric material 323 is injected into the mold cavity 302 via one or more inlets in the first die 304 and/or the second die 306. In the depicted embodiment, the second die 306 comprises inlets 324 and 326 for injecting the polymeric material 323. The polymeric material 323 may be any of the materials described herein with respect to the carrier 250 (see FIG. 2) in a molten state such that the polymeric material flows into the mold cavity 302 around the one or more positive surface features 316 and inserts 320 (e.g., such that the polymeric material contacts and surrounds the one or more positive surface features 316 and inserts 320) and into the one or more negative surface features 318. The molten polymeric material is subsequently cooled and solidified to form a carrier 340 (see FIG. 3C). The volume of polymeric material injected and the temperature to which the mold cavity 302 is heated may vary depending on the polymeric material used and the size of the glass article 300.

In embodiments, a plurality of polymeric materials are injected onto the glass substrate in sequence to form a multi-material carrier. For example, in embodiments, a first polymeric material may be initially deposited onto the decorative ink layer 245 to form a first carrier portion 328. After the first polymeric material is solidified, a second polymeric material 330 is deposited onto the first carrier portion 328. The second polymeric material may contact the second mold surface 312 prior to solidifying to form a second carrier portion 342 (see FIG. 3C) comprising the features generated via the discontinuities in the second mold surface 312. The first polymeric material used to form the first carrier portion 328 may have a Young's modulus (when solidified) that is less than a Young's modulus of the second polymeric material used to form the second carrier portion 342. Such a structure facilitates aids in reducing thermally-induced stresses in the carrier 340 (see FIG. 3C) when installed in a vehicle interior and subjected to variable temperature environments.

FIG. 3C depicts the glass article 300 after removal from the mold cavity 302. As shown, the glass article 300 comprises a carrier 340 bonded to the decorative ink layer 245 formed via the previously-described insert injection molding process. The carrier 340 comprises a main body 341. In the depicted example, both the main body 341 and the glass substrate 240 are substantially flat and planar shaped. The main body 341 may generally be flexible such that the glass substrate 240 and carrier 340 can be bent in conjunction with one another to facilitate mechanical attachment to a support structure (e.g., like the support structure 260 described herein with respect to FIG. 2) for retention in a desired curved shape. The generally flat structure of the glass article 300 facilitates relatively low-cost storage and shipment thereof.

The carrier 340 further comprises a plurality of connection elements 344. In the depicted embodiment, the plurality of connection elements 344 extend from the main body 341. The plurality of connection elements 344 may be formed from at least one of the negative surface features 318 in the second mold surface 312 (see FIGS. 3A and 3B) and the inserts 320, which may be embedded in the main body 341 and a component of the carrier 340. The plurality of connection elements 344 may extend away from the main body 341 and include one or more engagement features (e.g., hole, clip, slot, groove) to facilitate mechanical engagement with a support structure. Embodiments are also envisioned where the engagement features are negative features in the carrier (e.g., holes, slots, grooves) that receive components of the support structure for attachment. The second mold surface 312 may be tailored to form connection elements of any suitable structure and arrangement.

In the embodiment depicted in FIG. 3C, the carrier 340 comprises one or more stress relief features 346. The stress relief features 346 are depicted to be slots in the main body 341 formed via the one or more positive surface features 316 of the second mold surface 312 (see FIG. 3B). The slots are disposed proximate to and on either side of the connection elements 344. The connection elements 344 may bend upon mechanical engagement with a support structure and represents points of relatively high bending stress in the carrier 340. The stress relief features 346 may aid in reducing this bending stress to improve the longevity of the glass article 300 when cold-formed. In embodiments, the stress relief features 346 are distributed throughout the entirety of the main body 341. In embodiments, the shape, pitch, depth and dimensions of the stress relief features 346 can vary over the length of the carrier 340 to keep peak strain in the carrier 340 below a threshold value, such as 0.5 to 5% allowable strain if the carrier 340 is made of a plastic material. In some embodiments, the maximum bending strain is less than or equal to 5% (e.g., less than or equal to 4.0%, less than or equal to 3.0%, less than or equal to 2.0%, less than or equal to 1.0%, less than or equal to 0.5%).

The depth and width of each of the stress relief features 346 may be a function of the maximum thickness of the main body 341. For instance, the depth of each of the stress relief features 346 may be less than 75% (e.g., less than 50%, less than 45%, less than 40%) of the maximum thickness. The width of each of the stress relief features 346 may be greater than or equal to 10% of the maximum thickness and less than or equal to 40% of the maximum thickness (e.g., greater than or equal to 15% of the maximum thickness and less than or equal to 35% of the maximum thickness, greater than or equal to 20% of the maximum thickness and less than or equal to 30% of the maximum thickness). In some instances, the spacing of the stress relief features 346 may also be a function of the thickness of the main body 341. For example, the distance, which could be a center-to-center distance or an edge-to-edge distance (along a direction in which a length of the glass substrate is measured), between each stress relief feature 346 may be greater than a maximum thickness of the main body 341. For example, a spacing between adjacent ones of the stress relief features 346 may be greater than or equal to 5 times the maximum thickness of the mid-frame (e.g., greater than or equal to 10 times the maximum thickness, greater than or equal to 15 times the maximum thickness, greater than or equal to 20 times the maximum thickness, less than or equal to 50 times the maximum thickness, less than or equal to 40 times the maximum thickness, and any and all combinations of such ranges and sub-ranges between the extreme values).

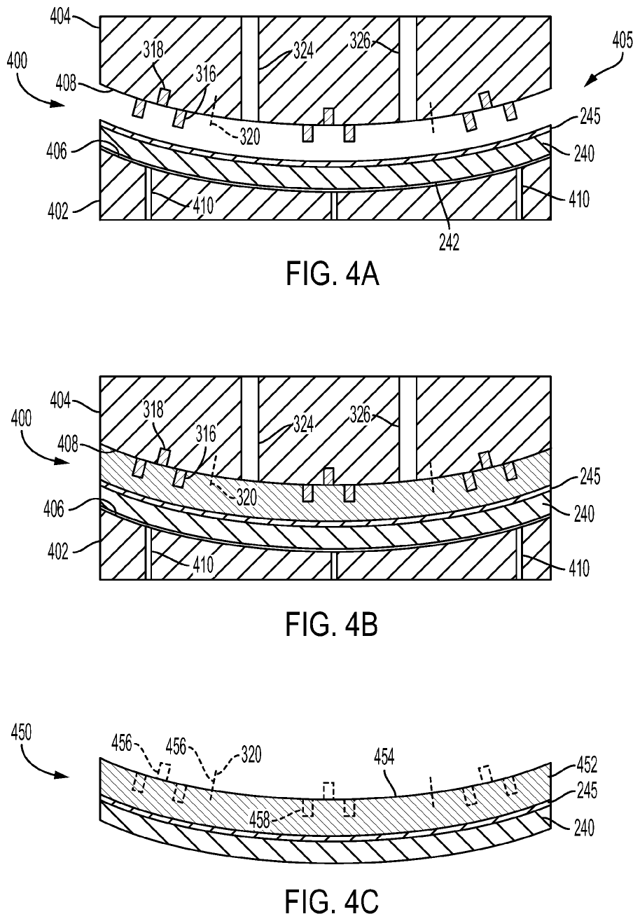

FIGS. 4A-4C schematically another process of fabricating a glass article 450, according to an example embodiment of the present disclosure. The process includes placing the glass substrate 240 into a mold cavity 400 defined between a first die 402 and a second die 404 of a molding apparatus 405. The glass substrate 240 is placed onto a first mold surface 406 of the first die 402. As shown, the process of FIGS. 4A-4C may differ from the process described herein with respect to FIGS. 3A-3C in that the first mold surface 406 is curved. In embodiments, the first mold surface 406 comprises a curved shape that corresponds or substantially corresponds to a final desired curved shape for the glass article 450. In embodiments, the first mold surface 406 may be curved to greater or lesser extent than desired in the glass article 450 in its final form when installed in a vehicle interior. In embodiments, the glass substrate 240 is cold-formed against the first mold surface 406 via application of an external force thereto. For example, in the depicted embodiment, the first die 402 comprises a plurality of vacuum openings 410. A suitable vacuum source may be in fluid communication with the plurality of vacuum openings to apply vacuum pressure to the glass substrate 240 and cold-form the glass substrate 240 against the first mold surface 406. Any suitable technique to cold-form the glass substrate 240 against the first mold surface 406 may be used.

As shown in FIG. 4B, once the glass substrate 240 is cold-formed against the first mold surface 406, the mold cavity 400 may be closed in manner similar to that described herein with respect to FIG. 3B. The second die 404 may be similar in structure to the second die 306 described herein with respect to FIGS. 3A-3C, and comprise a discontinuous mold surface with a plurality of positive surface features 316, a plurality of negative surface features 318, and a plurality of inserts 320, as described herein. The shape of the second mold surface 408 forming the mold cavity 400 may vary depending on a desired shape of the glass article 450 (see FIG. 4C). In the depicted embodiment, the second mold surface 408 is curved and extends parallel to the first mold surface 406, though alternative embodiments are envisioned where the second mold surface 408 is flat or curved to a different extent and/or direction than the first mold surface 406.

Once the mold cavity 400 is closed, a suitable polymeric material may be injected into the mold cavity 400 via inlets 324 and 326 in the second die 404. The polymeric material may bond with the decorative ink layer 245 or a suitable adhesion promotion layer disposed thereon and solidify to form a carrier 452 of the glass article 450 (see FIG. 4C). The polymeric material is injected onto the decorative ink layer 245 when in a molten state and when the glass substrate 240 is cold-formed via the first die 402. As described herein, the shape and functionality of the carrier 250 may vary depending on the shape of the second mold surface 408.

As shown in FIG. 4C, the carrier 452 comprises a main body 454, a plurality of connection elements 456, and a plurality of stress relief features 458. The plurality of connection elements 456 and stress relief features 458 may function similarly to the plurality of connection elements 344 and plurality of stress relief features 346 described herein with respect to FIG. 3C. The shape of the main body 454 may vary depending on the implementation. In embodiments, the shape of the main body 454 (e.g., thickness) and composition of the polymeric material may be selected such that the main body 454 is less rigid (e.g., less resistant to bending) than the glass substrate 240, such that, upon removal of the force supplied via the first die 402, the glass substrate 240 springs back to initial state, causing the main body 454 to bend relative to its as-formed shape (in the mold cavity 400). When installed in a vehicle interior, the glass article 450 may be bent such that the main body 454 re-assumes its as-formed shape. Such embodiments may be beneficial in that relatively little bending stresses may be present in the main body 454 when the glass article 450 is installed in a vehicle.

In embodiments, the shape of the main body 454 (e.g., thickness) and composition of the polymeric material may be selected such that the main body 454 is more rigid than the glass substrate 240 such that, upon removal from the mold cavity 400, the main body 454 retains the glass substrate 240 in a cold-bent state with an asymmetric surface compressive stress distribution. Such a glass article 450 may be installed in a vehicle interior such that no bending stress is present in the carrier 452. When the glass substrate 240 is in a cold-bent state, the glass article 450 may also be bent for installation via the plurality of connection elements 456 much that the shape of the glass substrate 240 differs from its shape after initially being cold-formed against the first mold surface 406. The carrier 452 may also include any of the features described herein with respect to FIGS. 3A-3C (e.g., a multi-material main body, differently structured connection elements, connection elements of different materials via the inserts 320, be structured into a plurality of different segments).

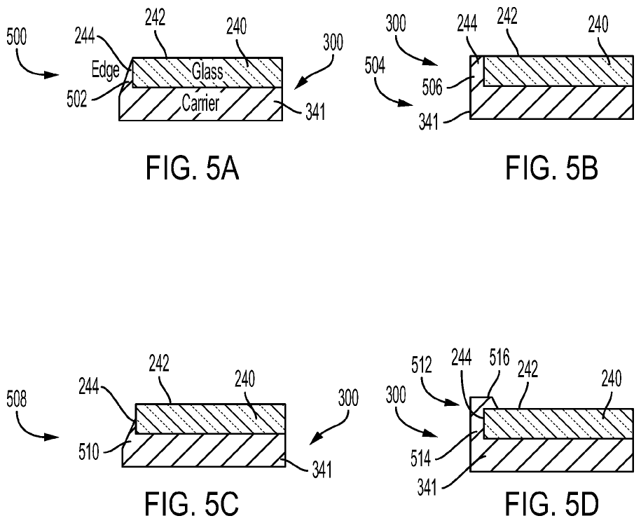

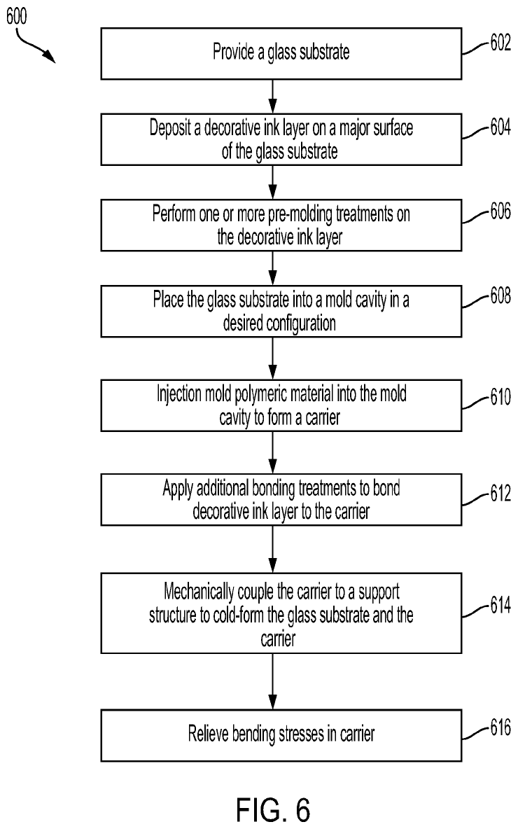

Referring generally to FIGS. 3A-3C and FIGS. 4A-4C, the insert injection molding process described herein facilitates flexibility in shaping the fabricated carrier. For example, referring to FIGS. 3A-3C, the shape of the first mold surface 310 and the second mold surface 312 proximate at a peripheral edge portion of the glass substrate 240 proximate to the minor surface 244 may be tailored to provide a desired peripheral edge extension of the carrier that extends along the minor surface 244. FIGS. 6A, 6B, 6C, and 6D schematically depict different peripheral edge portions of the glass article 300 according to various embodiments. FIG. 5A depicts a first peripheral edge portion 500 comprising a peripheral edge extension 502 extending from the main body 341 along the minor surface 244. The peripheral edge extension 502 may extend along an entire periphery of the glass substrate 240. In embodiments the peripheral edge extension 502 is bonded to the glass substrate 240 (e.g., the decorative ink layer 245 (not shown) or adhesion promotion layer may also be disposed on the minor surface 244 to facilitate bonding between the peripheral edge extension 502 and the minor surface 244). It has been found that such bonding between the peripheral edge extension 502 and the minor surface 244 improves longevity of the glass article. In FIG. 5A, the peripheral edge extension comprises a tapered structure with a width with that decreases with increasing distance from the main body 341. Such a structure may aid in reducing the visibility of the peripheral edge extension 502. The peripheral edge extension 502 may also beneficially protect the minor surface 244 of the glass substrate 240 when installed in a vehicle interior.

The mold surfaces described herein may be structured to provide peripheral edge extensions with a variety of different structures. For example, FIG. 5B depicts a second peripheral edge portion 504 where the main body 341 comprises a peripheral edge extension 506 that is co-extensive with the minor surface 244 and comprises a constant width. FIG. 5C depicts a third peripheral edge portion 508 where the main body 341 comprises a peripheral edge extension 510 that is bonded to only a part of the minor surface 244. Such a structure may enhance the bonding strength between the carrier 340 and glass substrate 240, while aid further in reducing the visibility of the peripheral edge extension. FIG. 5D depicts a fourth peripheral edge portion 512 where the main body 341 comprises a peripheral edge extension 514 including a front portion 516 that is also in contact with the first major surface 242. In this embodiment, the carrier completely encapsulates the peripheral edge of the glass substrate 240 to protect the glass substrate and improve bonding between the glass substrate 240 and the carrier 340. As demonstrated by the preceding examples, a variety of structures are contemplated and within the scope of the present disclosure.

FIG. 6 depicts a flow diagram of a method 600 of fabricating a glass article, according to an example embodiment. The method 600 may be used to fabricate any of the glass articles described herein, as well as other glass articles. For example, the method 600 may be used to fabricate the glass article 300 described herein with respect to FIGS. 3A-3C. Accordingly, reference will be made to various components depicted in FIGS. 3A-3C to aid in the description of the method 600. At block 602, the glass substrate 240 is provided. The glass substrate 240 may be commercially purchased or fabricated using various suitable techniques (e.g., down-draw processes, float processes) and have any suitable composition. At block 604, the decorative ink layer 245 is deposited on the second major surface 243. The decorative ink layer 245 may be deposited in any suitable pattern (e.g., uniformly or other pattern) using any suitable technique (e.g., inkjet printing, spray coating, other coating technique).

At block 606, the method 600 may optionally include performing one or more pre-molding treatments on the decorative ink layer 245. Such pre-molding treatments may include depositing an adhesion promotion layer on the decorative ink layer to promote bonding with the carrier 340. Pre-molding treatments may also include promoting bonding by additively manufacturing filaments of polymeric material on the decorative ink layer 245. Pre-molding treatments may also include texturing one or more portions of the decorative ink layer using chemical etching or mechanical abrasion to promote bonding. Pre-molding treatments may also include suitable plasma treatments to at least a portion of the surface area of the decorative ink layer 245.

At block 608, the glass substrate 240 is placed into the mold cavity 302. The mold cavity 302 is defined by a first die 304 with a first mold surface 310 and a second die 306 with a second mold surface 312. The first and second mold surfaces 310 and 312 are shaped to form a carrier with a desired shape having a desired arrangement of features. Prior to or after the glass substrate 240 is placed into the mold cavity 302, the method 600 may optionally include cold-forming the glass substrate 240 to a desired shape.

At block 610, the mold cavity 302 is closed and at least one polymeric material is injected into the mold cavity 302 to form the carrier 340. The polymeric material may be any suitable material depending on the desired thermal and mechanical properties of the carrier 340. The polymeric material is injected into the mold cavity 302 via one or more of the inlets 324 and 326 while in a liquid state and subsequently solidified to form the carrier 340. In embodiments, a plurality of polymeric materials are sequentially injected into the mold cavity to form a carrier of a plurality of different materials. In embodiments, the glass substrate 240 may be removed from the mold cavity 302 after injection of a first polymeric material and subsequently placed in a different molding cavity to form another carrier portion on the initially injected polymeric material.

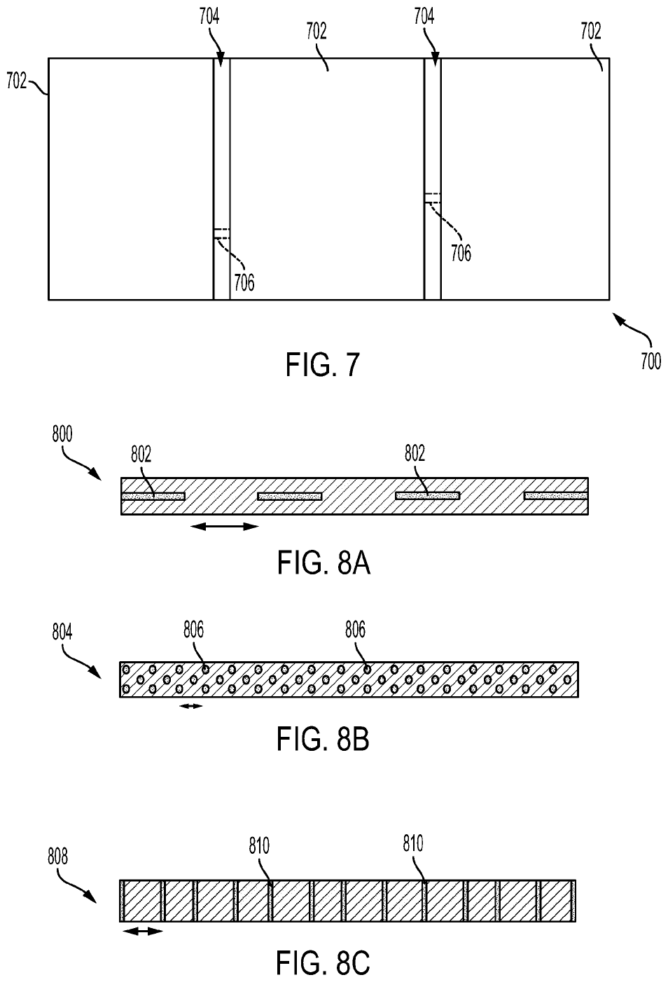

As described herein, the mold cavity 302 may be structured such that the carrier 340 has any suitable shape and set of features. For example, FIG. 7 schematically depicts a plan view of a segmented carrier 700. The segmented carrier 700 may be similar in structure to the carrier 340 described herein with respect to FIGS. 3A-3C, with the exception that the segmented carrier 700 comprises a plurality of segments 702 that are separated from one another via one or more stress relief joints 704. The plurality of segments 702 are portions of polymeric material injected into the mold cavity 302 (see FIG. 3B). The plurality of segments 702 have one or more degrees of freedom relative to one another via the one or more stress relief joints 704. The plurality of segments 702 represent portions of the segmented carrier 700 that are continuously bonded to the glass substrate 240 (see FIG. 3C), such that the stress relief joints 704 reduce the size of areas of the segmented carrier 700 that are continuously bonded to the glass substrate 240 to reduce the maximum thermally-induced stresses that are imparted on the segmented carrier 700. In embodiments, each of the plurality of segments 702 comprises at least two of the plurality of connection elements 344 (see FIG. 3C) such that each of the plurality of segments 702 can be curved upon mechanical engagement with a suitable support structure. In embodiments, the one or more stress relief joints 704 extend in a direction perpendicular to a direction along which the first major surface 242 (see FIG. 3C) of the glass substrate 240 has a minimum radius of curvature to provide bending stress relief.

In embodiments, the plurality of segments 702 are connected to one another via one or more connection structures 706 extending across the one or more stress relief joints 704. The connection structures 706 may aid in retaining the segmented carrier 700 in a desired shape, while still allowing the plurality of segments 702 to move relative to one another to reduce thermal-induced stresses. In embodiments, any of the structures described in U.S. patent application Ser. No. 17/637,571, filed on Jul. 12, 2021, or U.S. Provisional Patent Application No. 63/275,738, filed on Nov. 4, 2021, each of which are hereby incorporated by reference in their entireties, may be used for the one or more connection structures 706.

Referring again to FIG. 6, in embodiments, after the carrier 340 is formed via injection molding (e.g., after the polymeric material solidifies), the glass article 300 is removed from the mold cavity 302. The shape of the glass article 300 may vary depending on the implementation (e.g., the glass article 300 may be flat or curved in various embodiments). In embodiments, at block 612, additional bonding treatments may be applied to the carrier 340 to increase the bonding strength between the carrier 340 and the glass substrate 240. For example, in embodiments, select regions of the carrier 340 may be heated after injection molding to re-melt the polymeric material to facilitate bond creation. Ultrasonic energy, laser energy, or heat from other suitable source (e.g., hot tooling, convective heating, conductive heating) may be used to selectively heat regions of the interface between the glass substrate 240 and the carrier 340. In embodiments, an entirety of the second major surface 343 is subjected to such additional energy to form a strong bond between the carrier 340 and the decorative ink layer 345 or a suitable adhesion promotion layer disposed thereon.

In embodiments, between the pre-molding treatments described with respect to the block 606 and the post-molding boding treatments described with respect to the block 612, the bonding strength between the carrier 340 and the glass substrate 240 may vary as a function of spatial position at the interface. For example, select areas of the decorative ink layer 245 may be textured using an etching process or activated using plasma treatments to provide areas of relatively high bonding strength. Alternatively or additionally, areas may be subjected to post-molding bonding treatments via application of laser or ultrasonic energy. Less than all of the area of the decorative ink layer 245 may be bonded to the carrier 340 at a maximum bonding strength. Such variable bonding strength may enable more glass/carrier relative motion during thermal cycling to reduce the thermal stresses in the bond.

FIGS. 8A-8C depict various patterns of relatively high bonding strength that may be achieved at blocks 606 and 612. For example, FIG. 8A depicts a first pattern 800 including strips 802 of relatively high bonding strength between the decorative ink layer 245 and the carrier 340 (see FIG. 3C). The strips 802 may extend along a direction in which the first major surface 242 is curved. FIG. 8B depicts a second pattern 804 comprising dots 806 of relatively high bonding strength. The dots 806 may be uniformly distributed over an entirety of the decorative ink layer 245. FIG. 8C depicts a third pattern 808 of strips 810 extending perpendicular relative to the strips 802 of FIG. 8A. The size, shape, and spacing the of the areas of relatively high bonding strength depicted in FIGS. 8A-8C may depend on the shape of the glass article 300 (e.g., the radius to which the glass article 300 is cold-formed, the size of the glass article 300) and the CTE difference between the glass substrate 240 and carrier 340. FIGS. 8A-8C depict only example patterns and it should be understood that patterns with features having various sizes and shapes are contemplated and within the scope of the present disclosure.

Referring again to FIG. 6, the method 600 may further include, at block 614, mechanically coupling the carrier 340 to the support structure 260 to retain the glass article 300 in a desired position or shape. For example, the plurality of connection elements 344 may mechanically engage (e.g., be inserted into, disposed around, snap into engagement with) with the plurality of retention elements 262 described herein with respect to FIG. 2 such that both the glass substrate 240 and carrier 340 are cold-formed and retained in a non-planar shape via the support structure 260. The nature of attachment between the plurality of connection elements 344 and plurality of retention elements 262 will vary depending on the structure of the carrier 340.

In embodiments, at block 616, the method 600 includes relieving bending stresses in the carrier 340 (when the carrier 340 is bent from an as-formed shape). A post-cold-forming process can be used to relieve stress in the carrier 340 by annealing. During an annealing process, plastic, glass, or ceramics are heated to a peak temperature less than or equal to glass transition temperature T_{g} of the carrier 340 (e.g., heated to a temperature of at most T_{g}−5° C. or at most T_{g}−10° C. or at most T_{g}−20° C. less than T_{g}) and slowly cooled, allowing a molecular arrangement that reduces macroscopic stress and strain in the component. Full annealing processes take a long time, in part because of the slow cooling rates. Times of 30 minutes to several hours at a temperature 5-10 C below the glass transition temperature T_{g} with a cooling rate of 5 degrees C. per minute are typical. In this case, full stress relaxation is the target. In manufacturing, the minimum annealing process and strain conditions are sought and may be completed at a faster and more efficient temperature cycle. The temperature cycle is dependent on several factors including the carrier 340 material, heat transfer efficiency, and desired final stress state.

In embodiments, to anneal the carrier 340, heat can be added to the carrier 340 by heating the glass article 300 and support structure 260 by air convection (i.e. a heat gun or similar) to specific locations, or by conduction (e.g., through handling fixtures or separate heating fixtures) in direct or very close contact with the assembly. After a specified dwell time, cooling can be controlled as necessary by reducing an amount of heat applied to the glass article 300 or removal of the heating appliance. The glass article 300 may be heated at localized regions where high strain is expected. Alternatively, all parts of the glass article 300 may be heated relatively evenly.

### Glass Substrate Properties

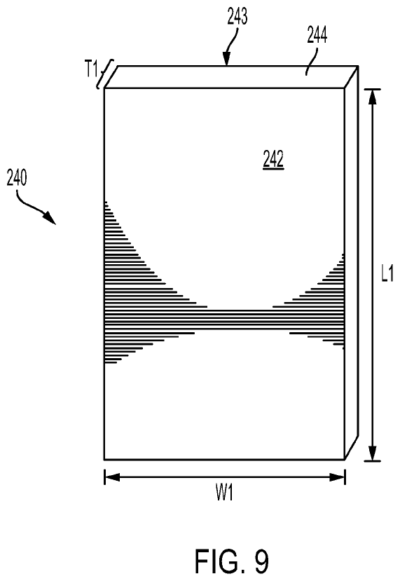

In the following paragraphs, various geometrical, mechanical, and strengthening properties of the glass substrate 240 as well as compositions of the glass substrate 240 are provided. Referring to FIG. 9, the glass substrate 240 has a thickness T1 that is substantially constant over the width and length of the glass substrate 240 and is defined as a distance between the first major surface 242 and the second major surface 243. In various embodiments, T1 may refer to an average thickness or a maximum thickness of the glass substrate 240. In addition, the glass substrate 240 includes a width W1 defined as a first maximum dimension of one of the first or second major surfaces 242, 243 orthogonal to the thickness T1, and a length L1 defined as a second maximum dimension of one of the first or second major surfaces 24, 243 orthogonal to both the thickness and the width. In other embodiments, W1 and L1 may be the average width and the average length of the glass substrate 240, respectively, and in other embodiments, W1 and L1 may be the maximum width and the maximum length of the glass substrate 240, respectively (e.g., for glass substrates 232 having a variable width or length).

In various embodiments, thickness T1 is 2 mm or less. In particular, the thickness T1 is from 0.30 mm to 2.0 mm. For example, thickness T1 may be in a range from about 0.30 mm to about 2.0 mm, from about 0.40 mm to about 2.0 mm, from about 0.50 mm to about 2.0 mm, from about 0.60 mm to about 2.0 mm, from about 0.70 mm to about 2.0 mm, from about 0.80 mm to about 2.0 mm, from about 0.90 mm to about 2.0 mm, from about 1.0 mm to about 2.0 mm, from about 1.1 mm to about 2.0 mm, from about 1.2 mm to about 2.0 mm, from about 1.3 mm to about 2.0 mm, from about 1.4 mm to about 2.0 mm, from about 1.5 mm to about 2.0 mm, from about 0.30 mm to about 1.9 mm, from about 0.30 mm to about 1.8 mm, from about 0.30 mm to about 1.7 mm, from about 0.30 mm to about 1.6 mm, from about 0.30 mm to about 1.5 mm, from about 0.30 mm to about 1.4 mm, from about 0.30 mm to about 1.4 mm, from about 0.30 mm to about 1.3 mm, from about 0.30 mm to about 1.2 mm, from about 0.30 mm to about 1.1 mm, from about 0.30 mm to about 1.0 mm, from about 0.30 mm to about 0.90 mm, from about 0.30 mm to about 0.80 mm, from about 0.30 mm to about 0.70 mm, from about 0.30 mm to about 0.60 mm, or from about 0.30 mm to about 0.40 mm. In other embodiments, the T1 falls within any one of the exact numerical ranges set forth in this paragraph.

In various embodiments, width W1 is in a range from 5 cm to 250 cm, from about 10 cm to about 250 cm, from about 15 cm to about 250 cm, from about 20 cm to about 250 cm, from about 25 cm to about 250 cm, from about 30 cm to about 250 cm, from about 35 cm to about 250 cm, from about 40 cm to about 250 cm, from about 45 cm to about 250 cm, from about 50 cm to about 250 cm, from about 55 cm to about 250 cm, from about 60 cm to about 250 cm, from about 65 cm to about 250 cm, from about 70 cm to about 250 cm, from about 75 cm to about 250 cm, from about 80 cm to about 250 cm, from about 85 cm to about 250 cm, from about 90 cm to about 250 cm, from about 95 cm to about 250 cm, from about 100 cm to about 250 cm, from about 110 cm to about 250 cm, from about 120 cm to about 250 cm, from about 130 cm to about 250 cm, from about 140 cm to about 250 cm, from about 150 cm to about 250 cm, from about 5 cm to about 240 cm, from about 5 cm to about 230 cm, from about 5 cm to about 220 cm, from about 5 cm to about 210 cm, from about 5 cm to about 200 cm, from about 5 cm to about 190 cm, from about 5 cm to about 180 cm, from about 5 cm to about 170 cm, from about 5 cm to about 160 cm, from about 5 cm to about 150 cm, from about 5 cm to about 140 cm, from about 5 cm to about 130 cm, from about 5 cm to about 120 cm, from about 5 cm to about 110 cm, from about 5 cm to about 110 cm, from about 5 cm to about 100 cm, from about 5 cm to about 90 cm, from about 5 cm to about 80 cm, or from about 5 cm to about 75 cm. In other embodiments, W1 falls within any one of the exact numerical ranges set forth in this paragraph.

In various embodiments, length L1 is in a range from about 5 cm to about 2500 cm, from about 5 cm to about 2000 cm, from about 4 to about 1500 cm, from about 50 cm to about 1500 cm, from about 100 cm to about 1500 cm, from about 150 cm to about 1500 cm, from about 200 cm to about 1500 cm, from about 250 cm to about 1500 cm, from about 300 cm to about 1500 cm, from about 350 cm to about 1500 cm, from about 400 cm to about 1500 cm, from about 450 cm to about 1500 cm, from about 500 cm to about 1500 cm, from about 550 cm to about 1500 cm, from about 600 cm to about 1500 cm, from about 650 cm to about 1500 cm, from about 650 cm to about 1500 cm, from about 700 cm to about 1500 cm, from about 750 cm to about 1500 cm, from about 800 cm to about 1500 cm, from about 850 cm to about 1500 cm, from about 900 cm to about 1500 cm, from about 950 cm to about 1500 cm, from about 1000 cm to about 1500 cm, from about 1050 cm to about 1500 cm, from about 1100 cm to about 1500 cm, from about 1150 cm to about 1500 cm, from about 1200 cm to about 1500 cm, from about 1250 cm to about 1500 cm, from about 1300 cm to about 1500 cm, from about 1350 cm to about 1500 cm, from about 1400 cm to about 1500 cm, or from about 1450 cm to about 1500 cm. In other embodiments, L1 falls within any one of the exact numerical ranges set forth in this paragraph.

In various embodiments, one or more radius of curvature of glass substrate 240 is about 50 mm or greater. For example, R may be in a range from about 50 mm to about 10,000 mm, from about 60 mm to about 10,000 mm, from about 70 mm to about 10,000 mm, from about 80 mm to about 10,000 mm, from about 90 mm to about 10,000 mm, from about 100 mm to about 10,000 mm, from about 120 mm to about 10,000 mm, from about 140 mm to about 10,000 mm, from about 150 mm to about 10,000 mm, from about 160 mm to about 10,000 mm, from about 180 mm to about 10,000 mm, from about 200 mm to about 10,000 mm, from about 220 mm to about 10,000 mm, from about 240 mm to about 10,000 mm, from about 250 mm to about 10,000 mm, from about 260 mm to about 10,000 mm, from about 270 mm to about 10,000 mm, from about 280 mm to about 10,000 mm, from about 290 mm to about 10,000 mm, from about 300 mm to about 10,000 mm, from about 350 mm to about 10,000 mm, from about 400 mm to about 10,000 mm, from about 450 mm to about 10,000 mm, from about 500 mm to about 10,000 mm, from about 550 mm to about 10,000 mm, from about 600 mm to about 10,000 mm, from about 650 mm to about 10,000 mm, from about 700 mm to about 10,000 mm, from about 750 mm to about 10,000 mm, from about 800 mm to about 10,000 mm, from about 900 mm to about 10,000 mm, from about 950 mm to about 10,000 mm, from about 1000 mm to about 10,000 mm, from about 1250 mm to about 10,000 mm, from about 50 mm to about 1400 mm, from about 50 mm to about 1300 mm, from about 50 mm to about 1200 mm, from about 50 mm to about 1100 mm, from about 50 mm to about 1000 mm, from about 50 mm to about 950 mm, from about 50 mm to about 900 mm, from about 50 mm to about 850 mm, from about 50 mm to about 800 mm, from about 50 mm to about 750 mm, from about 50 mm to about 700 mm, from about 50 mm to about 650 mm, from about 50 mm to about 600 mm, from about 50 mm to about 550 mm, from about 50 mm to about 500 mm, from about 50 mm to about 450 mm, from about 50 mm to about 400 mm, from about 50 mm to about 350 mm, from about 50 mm to about 300 mm, or from about 50 mm to about 250 mm. In other embodiments, R falls within any one of the exact numerical ranges set forth in this paragraph.

The various embodiments of the vehicle interior system may be incorporated into vehicles such as trains, automobiles (e.g., cars, trucks, buses and the like), sea craft (boats, ships, submarines, and the like), and aircraft (e.g., drones, airplanes, jets, helicopters and the like).

### Strengthened Glass Properties

The glass substrate 240 may be strengthened. In one or more embodiments, glass substrate 240 may be strengthened to include compressive stress that extends from a surface to a depth of compression (DOC). The compressive stress regions are balanced by a central portion exhibiting a tensile stress. At the DOC, the stress crosses from a positive (compressive) stress to a negative (tensile) stress.

In various embodiments, glass substrate 240 may be strengthened mechanically by utilizing a mismatch of the coefficient of thermal expansion between portions of the article to create a compressive stress region and a central region exhibiting a tensile stress. In some embodiments, the glass substrate 240 may be strengthened thermally by heating the glass to a temperature above the glass transition point and then rapidly quenching.

In various embodiments, glass substrate 240 may be chemically strengthened by ion exchange. In the ion exchange process, ions at or near the surface of the glass substrate 240 are replaced by—or exchanged with—larger ions having the same valence or oxidation state. In those embodiments in which the glass substrate 240 comprises an alkali aluminosilicate glass, ions in the surface layer of the article and the larger ions are monovalent alkali metal cations, such as Li⁺, Na⁺, K⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into the glass substrate generate a stress.

Ion exchange processes are typically carried out by immersing a glass substrate 240 in a molten salt bath (or two or more molten salt baths) containing the larger ions to be exchanged with the smaller ions in the glass substrate 240. It should be noted that aqueous salt baths may also be utilized. In addition, the composition of the bath(s) may include more than one type of larger ions (e.g., Na+ and K+) or a single larger ion. It will be appreciated by those skilled in the art that parameters for the ion exchange process, including, but not limited to, bath composition and temperature, immersion time, the number of immersions of the glass substrate 240 in a salt bath (or baths), use of multiple salt baths, additional steps such as annealing, washing, and the like, are generally determined by the composition of the glass substrate 240 (including the structure of the article and any crystalline phases present) and the desired DOC and CS of the glass substrate 240 that results from strengthening. Exemplary molten bath compositions may include nitrates, sulfates, and chlorides of the larger alkali metal ion. Typical nitrates include KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on glass substrate thickness, bath temperature and glass (or monovalent ion) diffusivity. However, temperatures and immersion times different from those described above may also be used.

In one or more embodiments, the glass substrates may be immersed in a molten salt bath of 100% NaNO₃, 100% KNO₃, or a combination of NaNO₃ and KNO₃ having a temperature from about 370° C. to about 480° C. In some embodiments, the glass substrate 240 may be immersed in a molten mixed salt bath including from about 5% to about 90% KNO₃ and from about 10% to about 95% NaNO₃. In one or more embodiments, the glass substrate 240 may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass substrate 240 may be immersed in a molten, mixed salt bath including NaNO₃ and KNO₃ (e.g., 49%/51%, 50%/50%, 51%/49%) having a temperature less than about 420° C. (e.g., about 400° C. or about 380° C.). for less than about 5 hours, or even about 4 hours or less.

Ion exchange conditions can be tailored to provide a “spike” or to increase the slope of the stress profile at or near the surface of the resulting glass substrate 240. The spike may result in a greater surface CS value. This spike can be achieved by a single bath or multiple baths, with the bath(s) having a single composition or mixed composition, due to the unique properties of the glass compositions used in the glass substrates described herein.

In one or more embodiments, where more than one monovalent ion is exchanged into the glass substrate, the different monovalent ions may exchange to different depths within the glass substrate 240 (and generate different magnitudes stresses within the glass substrate 240 at different depths). The resulting relative depths of the stress-generating ions can be determined and cause different characteristics of the stress profile.

CS is measured using those means known in the art, such as by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method. As used herein CS may be the “maximum compressive stress” which is the highest compressive stress value measured within the compressive stress layer. In some embodiments, the maximum compressive stress is located at the surface of the glass substrate 240. In other embodiments, the maximum compressive stress may occur at a depth below the surface, giving the compressive profile the appearance of a “buried peak.”

DOC may be measured by FSM or by a scattered light polariscope (SCALP) (such as the SCALP-04 scattered light polariscope available from GlasStress Ltd., located in Tallinn Estonia), depending on the strengthening method and conditions. When the glass substrate 240 is chemically strengthened by an ion exchange treatment, FSM or SCALP may be used depending on which ion is exchanged into the glass substrate 240. Where the stress in the glass substrate 240 is generated by exchanging potassium ions into the glass substrate, FSM is used to measure DOC. Where the stress is generated by exchanging sodium ions into the glass substrate 240, SCALP is used to measure DOC. Where the stress in the glass substrate 240 is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass substrates is measured by FSM. Central tension or CT is the maximum tensile stress and is measured by SCALP.

In one or more embodiments, the glass substrate 240 may be strengthened to exhibit a DOC that is described as a fraction of the thickness T1 of the glass substrate 240 (as described herein). For example, in one or more embodiments, the DOC may be equal to or greater than about 0.05T1, equal to or greater than about 0.1T1, equal to or greater than about 0.11T1, equal to or greater than about 0.12T1, equal to or greater than about 0.13T1, equal to or greater than about 0.14T1, equal to or greater than about 0.15T1, equal to or greater than about 0.16T1, equal to or greater than about 0.17T1, equal to or greater than about 0.18T1, equal to or greater than about 0.19T1, equal to or greater than about 0.2T1, equal to or greater than about 0.21T1. In some embodiments, the DOC may be in a range from about 0.08T1 to about 0.25T1, from about 0.09T1 to about 0.25T1, from about 0.18T1 to about 0.25T1, from about 0.11T1 to about 0.25T1, from about 0.12T1 to about 0.25T1, from about 0.13T1 to about 0.25T1, from about 0.14T1 to about 0.25T1, from about 0.15T1 to about 0.25T1, from about 0.08T1 to about 0.24T1, from about 0.08T1 to about 0.23T1, from about 0.08T1 to about 0.22T1, from about 0.08T1 to about 0.21T1, from about 0.08T1 to about 0.2T1, from about 0.08T1 to about 0.19T1, from about 0.08T1 to about 0.18T1, from about 0.08T1 to about 0.17T1, from about 0.08T1 to about 0.16T1, or from about 0.08T1 to about 0.15T1. In some instances, the DOC may be about 20 μm or less. In one or more embodiments, the DOC may be about 40 μm or greater (e.g., from about 40 μm to about 300 μm, from about 50 μm to about 300 μm, from about 60 μm to about 300 μm, from about 70 μm to about 300 μm, from about 80 μm to about 300 μm, from about 90 μm to about 300 μm, from about 100 μm to about 300 μm, from about 110 μm to about 300 μm, from about 120 μm to about 300 μm, from about 140 μm to about 300 μm, from about 150 μm to about 300 μm, from about 40 μm to about 290 μm, from about 40 μm to about 280 μm, from about 40 μm to about 260 μm, from about 40 μm to about 250 μm, from about 40 μm to about 240 μm, from about 40 μm to about 230 μm, from about 40 μm to about 220 μm, from about 40 μm to about 210 μm, from about 40 μm to about 200 μm, from about 40 μm to about 180 μm, from about 40 μm to about 160 μm, from about 40 μm to about 150 μm, from about 40 μm to about 140 μm, from about 40 μm to about 130 μm, from about 40 μm to about 120 μm, from about 40 μm to about 110 μm, or from about 40 μm to about 100 μm. In other embodiments, DOC falls within any one of the exact numerical ranges set forth in this paragraph.

In one or more embodiments, the glass substrate 240 may have a CS (which may be found at the surface or a depth within the glass substrate 240) of about 200 MPa or greater, 300 MPa or greater, 400 MPa or greater, about 500 MPa or greater, about 600 MPa or greater, about 700 MPa or greater, about 800 MPa or greater, about 900 MPa or greater, about 930 MPa or greater, about 1000 MPa or greater, or about 1050 MPa or greater.

In one or more embodiments, the glass substrate 240 may have a maximum tensile stress or central tension (CT) of about 20 MPa or greater, about 30 MPa or greater, about 40 MPa or greater, about 45 MPa or greater, about 50 MPa or greater, about 60 MPa or greater, about 70 MPa or greater, about 75 MPa or greater, about 80 MPa or greater, or about 85 MPa or greater. In some embodiments, the maximum tensile stress or central tension (CT) may be in a range from about 40 MPa to about 100 MPa. In other embodiments, CS falls within the exact numerical ranges set forth in this paragraph.

### Glass Compositions

Suitable glass compositions for use in glass substrate 240 include soda lime glass, aluminosilicate glass, borosilicate glass, boroaluminosilicate glass, alkali-containing aluminosilicate glass, alkali-containing borosilicate glass, and alkali-containing boroaluminosilicate glass.

Unless otherwise specified, the glass compositions disclosed herein are described in mole percent (mol %) as analyzed on an oxide basis.

In one or more embodiments, the glass composition may include SiO₂ in an amount in a range from about 66 mol % to about 80 mol %, from about 67 mol % to about 80 mol %, from about 68 mol % to about 80 mol %, from about 69 mol % to about 80 mol %, from about 70 mol % to about 80 mol %, from about 72 mol % to about 80 mol %, from about 65 mol % to about 78 mol %, from about 65 mol % to about 76 mol %, from about 65 mol % to about 75 mol %, from about 65 mol % to about 74 mol %, from about 65 mol % to about 72 mol %, or from about 65 mol % to about 70 mol %, and all ranges and sub-ranges therebetween.

In one or more embodiments, the glass composition includes Al₂O₃ in an amount greater than about 4 mol %, or greater than about 5 mol %. In one or more embodiments, the glass composition includes Al₂O₃ in a range from greater than about 7 mol % to about 15 mol %, from greater than about 7 mol % to about 14 mol %, from about 7 mol % to about 13 mol %, from about 4 mol % to about 12 mol %, from about 7 mol % to about 11 mol %, from about 8 mol % to about 15 mol %, from about 9 mol % to about 15 mol %, from about 10 mol % to about 15 mol %, from about 11 mol % to about 15 mol %, or from about 12 mol % to about 15 mol %, and all ranges and sub-ranges therebetween. In one or more embodiments, the upper limit of Al₂O₃ may be about 14 mol %, 14.2 mol %, 14.4 mol %, 14.6 mol %, or 14.8 mol %.

In one or more embodiments, the glass article is described as an aluminosilicate glass article or including an aluminosilicate glass composition. In such embodiments, the glass composition or article formed therefrom includes SiO₂ and Al₂O₃ and is nota soda lime silicate glass. In this regard, the glass composition or article formed therefrom includes Al₂O₃ in an amount of about 2 mol % or greater, 2.25 mol % or greater, 2.5 mol % or greater, about 2.75 mol % or greater, about 3 mol % or greater.

In one or more embodiments, the glass composition comprises B₂O₃ (e.g., about 0.01 mol % or greater). In one or more embodiments, the glass composition comprises B₂O₃ in an amount in a range from about 0 mol % to about 5 mol %, from about 0 mol % to about 4 mol %, from about 0 mol % to about 3 mol %, from about 0 mol % to about 2 mol %, from about 0 mol % to about 1 mol %, from about 0 mol % to about 0.5 mol %, from about 0.1 mol % to about 5 mol %, from about 0.1 mol % to about 4 mol %, from about 0.1 mol % to about 3 mol %, from about 0.1 mol % to about 2 mol %, from about 0.1 mol % to about 1 mol %, from about 0.1 mol % to about 0.5 mol %, and all ranges and sub-ranges therebetween. In one or more embodiments, the glass composition is substantially free of B₂O₃.

As used herein, the phrase “substantially free” with respect to the components of the composition means that the component is not actively or intentionally added to the composition during initial batching, but may be present as an impurity in an amount less than about 0.001 mol %.

In one or more embodiments, the glass composition optionally comprises P₂O₅ (e.g, about 0.01 mol % or greater). In one or more embodiments, the glass composition comprises a non-zero amount of P₂O₅ up to and including 2 mol %, 1.5 mol %, 1 mol %, or 0.5 mol %. In one or more embodiments, the glass composition is substantially free of P₂O₅.

In one or more embodiments, the glass composition may include a total amount of R₂O (which is the total amount of alkali metal oxide such as Li₂O, Na₂O, K₂O, Rb₂O, and Cs₂O) that is greater than or equal to about 8 mol %, greater than or equal to about 10 mol %, or greater than or equal to about 12 mol %. In some embodiments, the glass composition includes a total amount of R₂O in a range from about 8 mol % to about 20 mol %, from about 8 mol % to about 18 mol %, from about 8 mol % to about 16 mol %, from about 8 mol % to about 14 mol %, from about 8 mol % to about 12 mol %, from about 9 mol % to about 20 mol %, from about 10 mol % to about 20 mol %, from about 11 mol % to about 20 mol %, from about 12 mol % to about 20 mol %, from about 13 mol % to about 20 mol %, from about 10 mol % to about 14 mol %, or from 11 mol % to about 13 mol %, and all ranges and sub-ranges therebetween. In one or more embodiments, the glass composition may be substantially free of Rb₂O, Cs₂O or both Rb₂O and Cs₂O. In one or more embodiments, the R₂O may include the total amount of Li₂O, Na₂O and K₂O only. In one or more embodiments, the glass composition may comprise at least one alkali metal oxide selected from Li₂O, Na₂O and K₂O, wherein the alkali metal oxide is present in an amount greater than about 8 mol % or greater.

In one or more embodiments, the glass composition comprises Na₂O in an amount greater than or equal to about 8 mol %, greater than or equal to about 10 mol %, or greater than or equal to about 12 mol %. In one or more embodiments, the composition includes Na₂O in a range from about from about 8 mol % to about 20 mol %, from about 8 mol % to about 18 mol %, from about 8 mol % to about 16 mol %, from about 8 mol % to about 14 mol %, from about 8 mol % to about 12 mol %, from about 9 mol % to about 20 mol %, from about 10 mol % to about 20 mol %, from about 11 mol % to about 20 mol %, from about 12 mol % to about 20 mol %, from about 13 mol % to about 20 mol %, from about 10 mol % to about 14 mol %, or from 11 mol % to about 16 mol %, and all ranges and sub-ranges therebetween.

In one or more embodiments, the glass composition includes less than about 4 mol % K₂O, less than about 3 mol % K₂O, or less than about 1 mol % K₂O. In some instances, the glass composition may include K₂O in an amount in a range from about 0 mol % to about 4 mol %, from about 0 mol % to about 3.5 mol %, from about 0 mol % to about 3 mol %, from about 0 mol % to about 2.5 mol %, from about 0 mol % to about 2 mol %, from about 0 mol % to about 1.5 mol %, from about 0 mol % to about 1 mol %, from about 0 mol % to about 0.5 mol %, from about 0 mol % to about 0.2 mol %, from about 0 mol % to about 0.1 mol %, from about 0.5 mol % to about 4 mol %, from about 0.5 mol % to about 3.5 mol %, from about 0.5 mol % to about 3 mol %, from about 0.5 mol % to about 2.5 mol %, from about 0.5 mol % to about 2 mol %, from about 0.5 mol % to about 1.5 mol %, or from about 0.5 mol % to about 1 mol %, and all ranges and sub-ranges therebetween. In one or more embodiments, the glass composition may be substantially free of K₂O.

In one or more embodiments, the glass composition is substantially free of Li₂O.

In one or more embodiments, the amount of Na₂O in the composition may be greater than the amount of Li₂O. In some instances, the amount of Na₂O may be greater than the combined amount of Li₂O and K₂O. In one or more alternative embodiments, the amount of Li₂O in the composition may be greater than the amount of Na₂O or the combined amount of Na₂O and K₂O.

In one or more embodiments, the glass composition may include a total amount of RO (which is the total amount of alkaline earth metal oxide such as CaO, MgO, BaO, ZnO and SrO) in a range from about 0 mol % to about 2 mol %. In some embodiments, the glass composition includes a non-zero amount of RO up to about 2 mol %. In one or more embodiments, the glass composition comprises RO in an amount from about 0 mol % to about 1.8 mol %, from about 0 mol % to about 1.6 mol %, from about 0 mol % to about 1.5 mol %, from about 0 mol % to about 1.4 mol %, from about 0 mol % to about 1.2 mol %, from about 0 mol % to about 1 mol %, from about 0 mol % to about 0.8 mol %, from about 0 mol % to about 0.5 mol %, and all ranges and sub-ranges therebetween.

In one or more embodiments, the glass composition includes CaO in an amount less than about 1 mol %, less than about 0.8 mol %, or less than about 0.5 mol %. In one or more embodiments, the glass composition is substantially free of CaO.

In some embodiments, the glass composition comprises MgO in an amount from about 0 mol % to about 7 mol %, from about 0 mol % to about 6 mol %, from about 0 mol % to about 5 mol %, from about 0 mol % to about 4 mol %, from about 0.1 mol % to about 7 mol %, from about 0.1 mol % to about 6 mol %, from about 0.1 mol % to about 5 mol %, from about 0.1 mol % to about 4 mol %, from about 1 mol % to about 7 mol %, from about 2 mol % to about 6 mol %, or from about 3 mol % to about 6 mol %, and all ranges and sub-ranges therebetween.

In one or more embodiments, the glass composition comprises ZrO₂ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises ZrO₂ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

In one or more embodiments, the glass composition comprises SnO₂ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises SnO₂ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

In one or more embodiments, the glass composition may include an oxide that imparts a color or tint to the glass articles. In some embodiments, the glass composition includes an oxide that prevents discoloration of the glass article when the glass article is exposed to ultraviolet radiation. Examples of such oxides include, without limitation oxides of: Ti, V, Cr, Mn, Fe, Co, Ni, Cu, Ce, W, and Mo.

In one or more embodiments, the glass composition includes Fe expressed as Fe₂O₃, wherein Fe is present in an amount up to (and including) about 1 mol %. In some embodiments, the glass composition is substantially free of Fe. In one or more embodiments, the glass composition comprises Fe₂O₃ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises Fe₂O₃ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

Where the glass composition includes TiO₂, TiO₂ may be present in an amount of about 5 mol % or less, about 2.5 mol % or less, about 2 mol % or less or about 1 mol % or less. In one or more embodiments, the glass composition may be substantially free of TiO₂.

An exemplary glass composition includes SiO₂ in an amount in a range from about 65 mol % to about 75 mol %, Al₂O₃ in an amount in a range from about 8 mol % to about 14 mol %, Na₂O in an amount in a range from about 12 mol % to about 17 mol %, K₂O in an amount in a range of about 0 mol % to about 0.2 mol %, and MgO in an amount in a range from about 1.5 mol % to about 6 mol %. Optionally, SnO₂ may be included in the amounts otherwise disclosed herein. It should be understood, that while the preceding glass composition paragraphs express approximate ranges, in other embodiments, glass substrate 240 may be made from any glass composition without falling with any one of the exact numerical ranges discussed above.

Embodiments of the present disclosure may be further understood in view of the following aspects:

An aspect (1) of the present disclosure pertains to a glass article comprising: a glass substrate comprising a first major surface and a second major surface opposite the first major surface; a decorative ink layer disposed on the second major surface of the glass substrate; and a carrier that is injection molded onto and bonded to the decorative ink layer, the carrier comprising: a main body comprising a surface bonded to the ink layer without an adhesive layer being disposed between the decorative ink layer and the surface; and a plurality of connection elements extending from the main body or incorporated into the main body; and a support structure comprising a plurality of retention elements that are configured to mechanically engage with the plurality of connection elements to retain the glass substrate and the carrier on the support structure in a curved configuration.

An aspect (2) of the present disclosure pertains to a glass article according to the aspect (1), wherein the carrier is less stiff than the glass substrate such that the carrier alone does not retain the glass substrate and carrier in the curved configuration.

An aspect (3) of the present disclosure pertains to a glass article according to the aspect (2), wherein the carrier and the glass substrate are cold-formed to facilitate mechanical engagement between the plurality of connection elements and the plurality of retention elements.

An aspect (4) of the present disclosure pertains to a glass article according to the aspect (3), wherein: as a result of being retained in the curved configuration, the first major surface is curved at a radius of curvature along a first direction, and the main body comprises one or more negative surface features disposed proximate to each of the plurality of connection elements, the negative surface features extending perpendicular to the first direction.

An aspect (5) of the present disclosure pertains to a glass article according to any of the aspects (1)-(4), wherein the plurality of connection elements extend from the main body and are integrally formed with the main body.

An aspect (6) of the present disclosure pertains to a glass article according to any of the aspects (1)-(4), wherein the plurality of connection elements are embedded into the main body and formed of first material that is different from a second material out of which the main body is formed.

An aspect (7) of the present disclosure pertains to a glass article according to any of the aspects (1)-(6), wherein at least the main body of the carrier is formed of a material comprising a polymeric matrix and at least 20% by volume of a glass fiber or carbon fiber additive.

An aspect (8) of the present disclosure pertains to a glass article according to any of the aspects (1)-(7), wherein the carrier is formed of at least one of a polycarbonate-based material, polyarylamide, or a polyphenylene sulfide-based material.

An aspect (9) of the present disclosure pertains to a glass article according to any of the aspects (1)-(8), wherein the decorative ink layer comprises at least one of an acrylic-based ink, an epoxy-based ink, a urethane-based ink, a thermoplastic polyolefin ink, a thermoplastic polyurethane ink, or a combination thereof.

An aspect (10) of the present disclosure pertains to a glass article according to any of the aspects (1)-(9), further comprising an adhesion promotion layer disposed between the decorative ink layer and the carrier, the adhesion promotion layer comprising at least one of chemical primer, a paint, or an ink having a composition that is different from the decorative ink layer.

An aspect (11) of the present disclosure pertains to a glass article according to any of the aspects (1)-(10), wherein at least a portion of the decorative ink layer is textured to facilitate bonding between the decorative ink layer and the carrier.

An aspect (12) of the present disclosure pertains to a glass article according to the aspect (11), wherein the portion of the decorative ink layer is textured via surface plasma activation.

An aspect (13) of the present disclosure pertains to a glass article according to any of the aspects (11)-(12), wherein the decorative ink layer is textured in a pattern such that a bond strength between the carrier and the decorative ink layer spatially varies as a function of position on the carrier to alleviate coefficient of thermal expansion-based stresses in the glass article.

An aspect (14) of the present disclosure pertains to a glass article according to any of the aspects (1)-(13), wherein: the glass substrate comprises a minor surface extending between the first major surface and the second major surface, and the carrier comprises a peripheral extension that contacts the minor surface.

An aspect (15) of the present disclosure pertains to a glass article according to the aspect (14), wherein the peripheral extension contacts an entirety of the minor surface.

An aspect (16) of the present disclosure pertains to a glass article according to the aspect (15), wherein the peripheral extension extends around a corner of the glass substrate and contacts the first major surface.

An aspect (17) of the present disclosure pertains to a glass article according to any of the aspects (1)-(16), wherein the main body comprises: a first portion that is directly bonded to the decorative ink layer or an adhesion promoting layer disposed thereon; and a second portion that is directly bonded to the first portion, wherein the second portion comprises Young's modulus that is greater than the first portion.

An aspect (18) of the present disclosure pertains to a glass article according to any of the aspects (1)-(17), wherein the main body comprises a plurality of segments and one or more stress relief joints disposed between the plurality of segments.

An aspect (19) of the present disclosure pertains to a glass article comprising: a glass substrate comprising a first major surface and a second major surface opposite the first major surface, wherein the glass substrate comprises a planar shape; a decorative ink layer disposed on the second major surface of the glass substrate; and a carrier that is injection molded onto and directly bonded to the decorative ink layer or an optional adhesion promotion layer disposed thereon, the carrier comprising: a planar-shaped main body comprising a surface bonded to the decorative ink layer without an adhesive layer being disposed between the decorative ink layer and the surface; and a plurality of connection elements extending from the main body or incorporated into the main body, wherein carrier is less stiff than the glass substrate and wherein the direct bonding between the glass substrate and the carrier via the decorative ink layer allows carrier and the glass substrate to be simultaneously bent to a radius of curvature that is less than or equal to 1.0 m without the carrier debonding from the glass substrate.

An aspect (20) of the present disclosure pertains to a glass article according to the aspect (19), wherein the main body comprises one or more negative surface features disposed proximate to each of the plurality of connection elements.

An aspect (21) of the present disclosure pertains to a glass article according to any of the aspects (19)-(20), wherein the plurality of connection elements extend from the main body and are integrally formed with the main body.

An aspect (22) of the present disclosure pertains to a glass article according to any of the aspects (19)-(20), wherein the plurality of connection elements are embedded into the main body and formed of first material that is different from a second material out of which the main body is formed.

An aspect (23) of the present disclosure pertains to a glass article according to any of the aspects (19)-(22), wherein at least the main body of the carrier is formed of a material comprising a polymeric matrix and at least 20% by volume of a glass fiber additive.

An aspect (24) of the present disclosure pertains to a glass article according to any of the aspects (19)-(23), wherein the carrier is formed of at least one of a polycarbonate-based material, polyarylamide, or a polyphenylene sulfide-based material.

An aspect (25) of the present disclosure pertains to a glass article according to any of the aspects (19)-(24), wherein the decorative ink layer comprises at least one of an acrylic-based ink, an epoxy-based ink, a urethane-based ink, a thermoplastic polyolefin ink, a thermoplastic polyurethane ink, or a combination thereof.

An aspect (26) of the present disclosure pertains to a glass article according to any of the aspects (19)-(25), further comprising the adhesion promotion layer disposed between the decorative ink layer and the carrier, the adhesion promotion layer comprising at least one of chemical primer, a paint, or an ink having a composition that is different from the decorative ink layer.

An aspect (27) of the present disclosure pertains to a glass article according to any of the aspects (19)-(26), wherein at least a portion of the decorative ink layer is textured to facilitate bonding between the decorative ink layer and the carrier.

An aspect (28) of the present disclosure pertains to a glass article according to the aspect (27), wherein the portion of the decorative ink layer is textured via surface plasma activation.

An aspect (29) of the present disclosure pertains to a glass article according to any of the aspects (27)-(28), wherein the decorative ink layer is textured in a pattern such that a bond strength between the carrier and the decorative ink layer spatially varies as a function of position on the carrier to alleviate coefficient of thermal expansion-based stresses in the glass article.

An aspect (30) of the present disclosure pertains to a glass article according to any of the aspects (19)-(29), wherein: the glass substrate comprises a minor surface extending between the first major surface and the second major surface, and the carrier comprises a peripheral extension that contacts the minor surface.

An aspect (31) of the present disclosure pertains to a glass article according to the aspect (30), wherein at least one of: the peripheral extension contacts an entirety of the minor surface, and the peripheral extension extends around a corner of the glass substrate and contacts the first major surface.

An aspect (32) of the present disclosure pertains to a glass article according to any of the aspects (19)-(31), wherein the main body comprises: a first portion that is directly bonded to the decorative ink layer or an adhesion promoting layer disposed thereon; and a second portion that is directly bonded to the first portion, wherein the second portion comprises Young's modulus that is greater than the first portion.

An aspect (33) of the present disclosure pertains to a glass article according to any of the aspects (19)-(32), wherein the main body comprises a plurality of segments and one or more stress relief joints disposed between the plurality of segments.

An aspect (34) of the present disclosure pertains to a method of fabricating a cold-formed glass article, the method comprising: depositing a decorative ink layer on a major surface of a glass substrate; disposing the glass substrate in a mold cavity defined between a first die and a second die, wherein the second die comprises a discontinuous mold surface that is not in contact with the glass substrate when the glass substrate is disposed in the mold cavity; injecting a polymeric material into the mold cavity such that the polymeric material fills a volume between the discontinuous mold surface and the glass substrate; solidifying the polymeric material to form a carrier that is directly bonded to the decorative ink layer or an adhesion promotion layer optionally disposed thereon; and cold-forming the glass substrate into a curved configuration.

An aspect (35) of the present disclosure pertains to a method according to the aspect (34), wherein the discontinuous mold surface comprises one or more positive surface features extending towards the glass substrate when the glass substrate is disposed in the mold cavity such that the carrier comprises one or more negative surface features.

An aspect (36) of the present disclosure pertains to a method according to any of the aspects (34)-(35), wherein the discontinuous mold surface comprises a plurality of negative surface features extending away from the glass substrate when the glass substrate is disposed in the mold cavity such that the carrier comprises a plurality of connection elements extending from a main body of the carrier.

An aspect (37) of the present disclosure pertains to a method according to any of the aspects (34)-(36), wherein the discontinuous mold surface comprises one or more carrier inserts removably attached thereto that are encapsulated in the solidified polymeric material and incorporated into the carrier.

An aspect (38) of the present disclosure pertains to a method according to any of the aspects (34)-(37), wherein the decorative ink layer comprises at least one of an acrylic-based ink, an epoxy-based ink, a urethane-based ink, a thermoplastic polyolefin ink, a thermoplastic polyurethane ink, or a combination thereof.

An aspect (39) of the present disclosure pertains to a method according to any of the aspects (34)-(38), further comprising disposing the adhesion promotion layer on the decorative ink layer prior disposing the glass substrate in the mold cavity, wherein the adhesion promotion layer comprises at least one of chemical primer, a paint, or an ink having a composition that is different from the decorative ink layer.

An aspect (40) of the present disclosure pertains to a method according to any of the aspects (34)-(39), the polymeric material comprises at least 20% by volume of a glass fiber or carbon fiber additive.

An aspect (41) of the present disclosure pertains to a method according to any of the aspects (34)-(40), wherein polymeric material comprises of at least one of a polycarbonate-based material, polyarylamide, or a polyphenylene sulfide-based material.

An aspect (42) of the present disclosure pertains to a method according to any of the aspects (34)-(41), further comprising selectively texturing the decorative ink layer prior to disposing the glass substrate in the mold cavity.

An aspect (43) of the present disclosure pertains to a method according to the aspect (43), wherein the selectively texturing comprises one or more plasma surface activation treatments.

An aspect (44) of the present disclosure pertains to a method according to any of the aspects (39)-(43), wherein, prior to being disposed in the mold cavity with the discontinuous surface, the method comprises disposing the glass substrate in an initial mold cavity and filling the mold cavity with an initial polymeric material to form a first portion of the carrier, the initial polymeric material, once cured, comprising a young's modulus that is less than the polymeric material.

An aspect (45) of the present disclosure pertains to a method according to any of the aspects (39)-(44), wherein the mold cavity is divided into a plurality of separate volumes such that the carrier is segmented.

An aspect (46) of the present disclosure pertains to a method according to any of the aspects (39)-(46), wherein the cold-forming occurs after carrier is directly bonded to the decorative ink layer or the adhesion promotion layer such that both the carrier and the glass substrate are bent during the cold-forming.

An aspect (47) of the present disclosure pertains to a method according to the aspect (46), wherein the cold-forming comprises mechanically attaching the carrier to a support structure without the use of an adhesive.

An aspect (48) of the present disclosure pertains to a method according to any of the aspects (34)-(47), further comprising, after the cold-forming, heating the glass substrate and carrier to relieve bending stresses in the carrier.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

1. A glass article comprising:
a glass substrate comprising a first major surface and a second major surface opposite the first major surface;
a decorative ink layer disposed on the second major surface of the glass substrate; and
a carrier that is injection molded onto and bonded to the decorative ink layer, the carrier comprising:
a main body comprising a surface bonded to the ink layer without an adhesive layer being disposed between the decorative ink layer and the surface; and
a plurality of connection elements extending from the main body or incorporated into the main body; and
a support structure comprising a plurality of retention elements that are configured to mechanically engage with the plurality of connection elements to retain the glass substrate and the carrier on the support structure in a curved configuration.

2. The glass article of claim 1, wherein the carrier is less stiff than the glass substrate such that the carrier alone does not retain the glass substrate and carrier in the curved configuration.

3. The glass article of claim 2, wherein the carrier and the glass substrate are cold-formed to facilitate mechanical engagement between the plurality of connection elements and the plurality of retention elements.

4. The glass article of claim 3, wherein:
as a result of being retained in the curved configuration, the first major surface is curved at a radius of curvature along a first direction, and
the main body comprises one or more negative surface features disposed proximate to each of the plurality of connection elements, the negative surface features extending perpendicular to the first direction.

5. The glass article of claim 1, wherein the plurality of connection elements extend from the main body and are integrally formed with the main body.

6. The glass article of claim 1, wherein the plurality of connection elements are embedded into the main body and formed of first material that is different from a second material out of which the main body is formed.

7. The glass article of claim 1, wherein at least the main body of the carrier is formed of a material comprising a polymeric matrix and at least 20% by volume of a glass fiber or carbon fiber additive.

8. The glass article of claim 1, wherein at least a portion of the decorative ink layer is textured to facilitate bonding between the decorative ink layer and the carrier.

9. (canceled)

10. The glass article of claim 8, wherein the decorative ink layer is textured in a pattern such that a bond strength between the carrier and the decorative ink layer spatially varies as a function of position on the carrier to alleviate coefficient of thermal expansion-based stresses in the glass article.

11. The glass article of claim 1, wherein:
the glass substrate comprises a minor surface extending between the first major surface and the second major surface, and
the carrier comprises a peripheral extension that contacts the minor surface.

12. The glass article of claim 11, wherein the peripheral extension contacts an entirety of the minor surface, wherein the peripheral extension extends around a corner of the glass substrate and contacts the first major surface.

13. The glass article of claim 1, wherein the main body comprises:
a first portion that is directly bonded to the decorative ink layer or an adhesion promoting layer disposed thereon; and
a second portion that is directly bonded to the first portion, wherein the second portion comprises Young's modulus that is greater than the first portion.

14. The glass article of claim 1, wherein the main body comprises a plurality of segments and one or more stress relief joints disposed between the plurality of segments.

15. A glass article comprising:
a glass substrate comprising a first major surface and a second major surface opposite the first major surface, wherein the glass substrate comprises a planar shape;
a decorative ink layer disposed on the second major surface of the glass substrate; and
a carrier that is injection molded onto and directly bonded to the decorative ink layer or an optional adhesion promotion layer disposed thereon, the carrier comprising:
a planar-shaped main body comprising a surface bonded to the decorative ink layer without an adhesive layer being disposed between the decorative ink layer and the surface; and
a plurality of connection elements extending from the main body or incorporated into the main body, wherein carrier is less stiff than the glass substrate and wherein the direct bonding between the glass substrate and the carrier via the decorative ink layer allows carrier and the glass substrate to be simultaneously bent to a radius of curvature that is less than or equal to 1.0 m without the carrier debonding from the glass substrate.

16. The glass article of claim 15, wherein the main body comprises one or more negative surface features disposed proximate to each of the plurality of connection elements.

17. The glass article of claim 15, wherein the plurality of connection elements are embedded into the main body and formed of first material that is different from a second material out of which the main body is formed.

18. (canceled)

19. (canceled)

20. (canceled)

21. (canceled)

22. (canceled)

23. (canceled)

24. (canceled)

25. A method of fabricating a cold-formed glass article, the method comprising:
depositing a decorative ink layer on a major surface of a glass substrate;
disposing the glass substrate in a mold cavity defined between a first die and a second die, wherein the second die comprises a discontinuous mold surface that is not in contact with the glass substrate when the glass substrate is disposed in the mold cavity;
injecting a polymeric material into the mold cavity such that the polymeric material fills a volume between the discontinuous mold surface and the glass substrate;
solidifying the polymeric material to form a carrier that is directly bonded to the decorative ink layer or an adhesion promotion layer optionally disposed thereon; and
cold-forming the glass substrate into a curved configuration.

26. The method of claim 25, wherein the discontinuous mold surface comprises one or more positive surface features extending towards the glass substrate when the glass substrate is disposed in the mold cavity such that the carrier comprises one or more negative surface features.

27. The method of claim 25, wherein the discontinuous mold surface comprises a plurality of negative surface features extending away from the glass substrate when the glass substrate is disposed in the mold cavity such that the carrier comprises a plurality of connection elements extending from a main body of the carrier.

28. (canceled)

29. The method of claim 25, wherein, prior to being disposed in the mold cavity with the discontinuous surface, the method comprises disposing the glass substrate in an initial mold cavity and filling the mold cavity with an initial polymeric material to form a first portion of the carrier, the initial polymeric material, once cured, comprising a young's modulus that is less than the polymeric material.

30. (canceled)
